(19) United States
(12) Patent Application Publication
(10) Pub. No.: US 2025/0338239 A1
(43) Pub. Date: Oct. 30, 2025

(54) METHODS, ARCHITECTURES, APPARATUSES AND SYSTEMS ENABLING ARTIFICIAL INTELLIGENCE APPLICATIONS IN NETWORKS

(71) Applicant: InterDigital Patent Holdings, Inc., Wilmington, DE (US)

(72) Inventors: Chonggang Wang, Princeton, NJ (US); Xu Li, Plainsboro, NJ (US); Efat Fathalla, Lexington, VA (US); Robert Gazda, Spring City, PA (US); Michel Roy, Candiac (CA)

(21) Appl. No.: 18/879,909

(22) PCT Filed: Jun. 26, 2023
(86) PCT No.: PCT/US2023/026183

§ 371 Date: Dec. 30, 2024

Related U.S. Application Data
(60) Provisional application No. 63/357,681, filed on Jul. 1, 2022.

(51) Int. Cl. H04W 60/00

(52) U.S. Cl. CPC H04W 60/00

(57) ABSTRACT

Procedures, methods, architectures, apparatuses, systems, devices, and computer program products for enabling AI applications in a network. A device receives, from an Artificial Intelligence, AI, entity, a first request for first registration, creates a record for the AI entity, the record comprising information indicative of the first registration, and transmits, to a further device, a second request for second registration of an AI client on the device and of at least one AI entity including the AI entity.

### BACKGROUND

The present disclosure is generally directed to the fields of communications, software and encoding, including, for example, to methods, architectures, apparatuses, systems directed to Artificial Intelligence (AI) applications in networks.

### SUMMARY

In a first aspect, the present principles are directed to a device comprising at least one processor configured to receive, from an Artificial Intelligence, AI, entity, a first request for first registration, create a record for the AI entity, the record comprising information indicative of the first registration, and transmit, to a further device, a second request for second registration of an AI client on the device and of at least one AI entity including the AI entity.

In a second aspect, the present principles are directed to a method, performed by a device, the method comprising receiving, from an Artificial Intelligence, AI, entity, a first request for first registration, creating a record for the AI entity, the record comprising information indicative of the first registration, and transmitting, to a further device, a second request for second registration of an AI client on the device and of at least one AI entity including the AI entity.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an AI host with an AI agent with an AI task using an AI model;

FIG. 3 illustrates a general AI pipeline for supervised learning;

FIG. 4 illustrates the general Federated Learning (FL) process;

FIG. 5 illustrates two examples of Deep Learning (DL) applications for wireless networks;

FIG. 6 illustrates an example of a FL application for wireless networks;

FIG. 7 illustrates an AI enabler service architecture according to a first embodiment of the present principles;

FIG. 8 illustrates an AI enabler service architecture according to a second embodiment of the present principles;

FIG. 9 illustrates a method of indirect AIAPP registration according to an embodiment;

FIG. 10 illustrates a method of direct AIAPP registration according to an embodiment of the present principles;

FIG. 11 illustrates a method of AIA registration according to an embodiment of the present principles;

FIG. 12 illustrates a method of AIA deployment according to an embodiment of the present principles;

FIG. 13 illustrates a method of AI task deployment according to an embodiment of the present principles;

FIG. 14 illustrates a method of AI task migration according to an embodiment of the present principles;

FIG. 15 illustrates a method of FL task migration according to an embodiment of the present principles;

FIG. 16 illustrates a method of AI model registration according to an embodiment of the present principles; and

FIG. 17 illustrates a method of AI model discovery and deployment according to an embodiment of the present principles.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

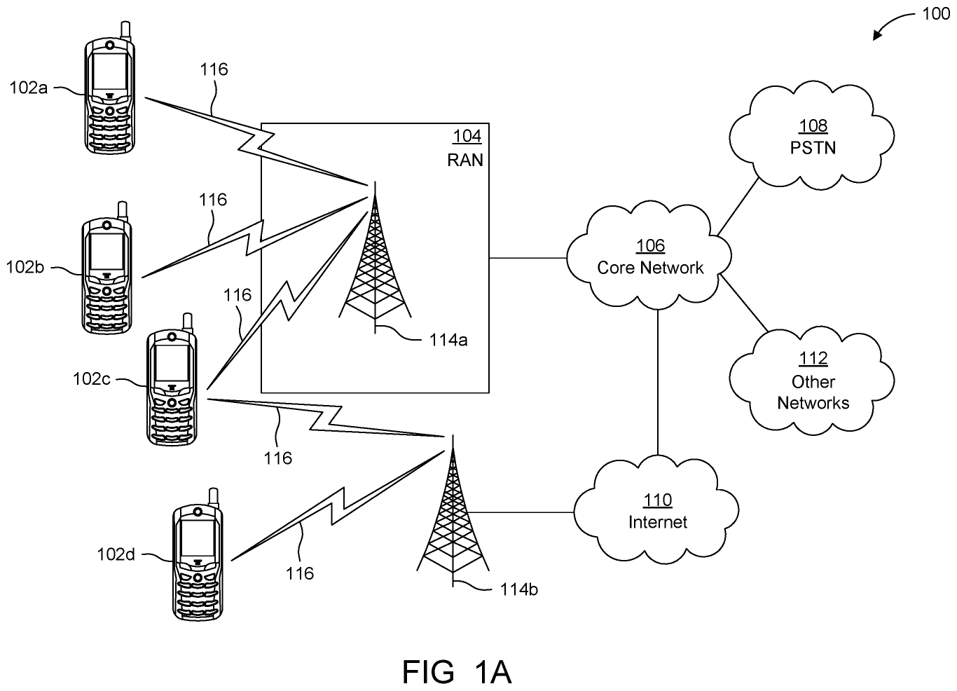

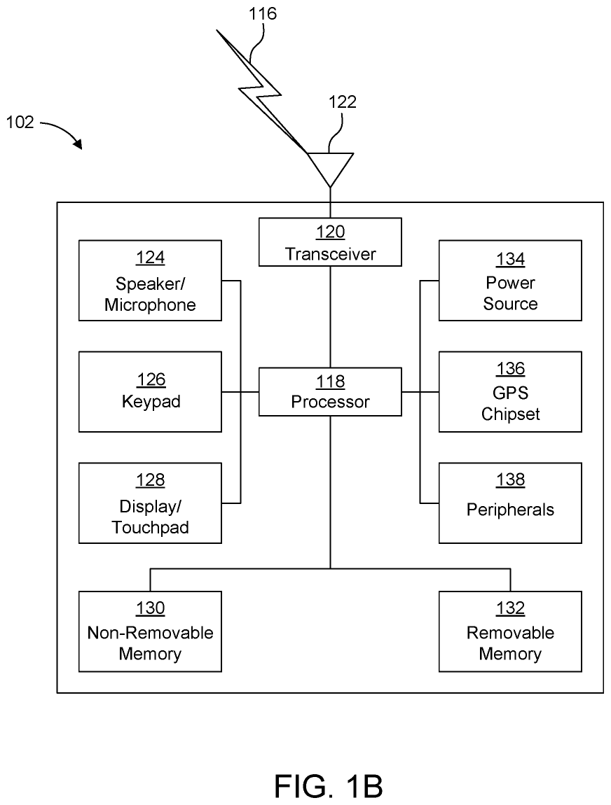

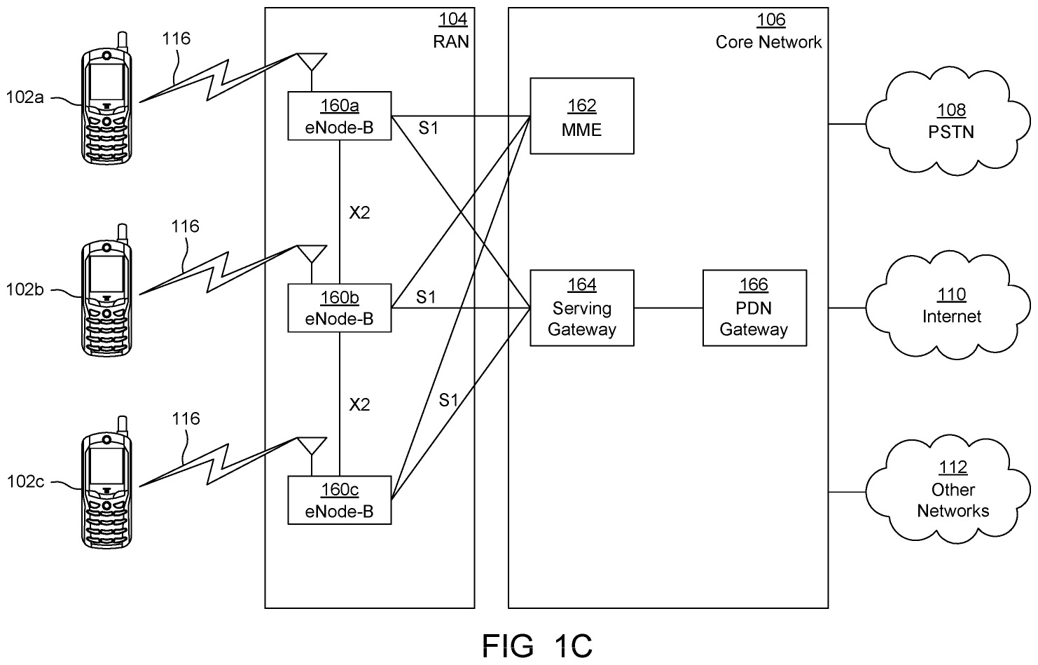

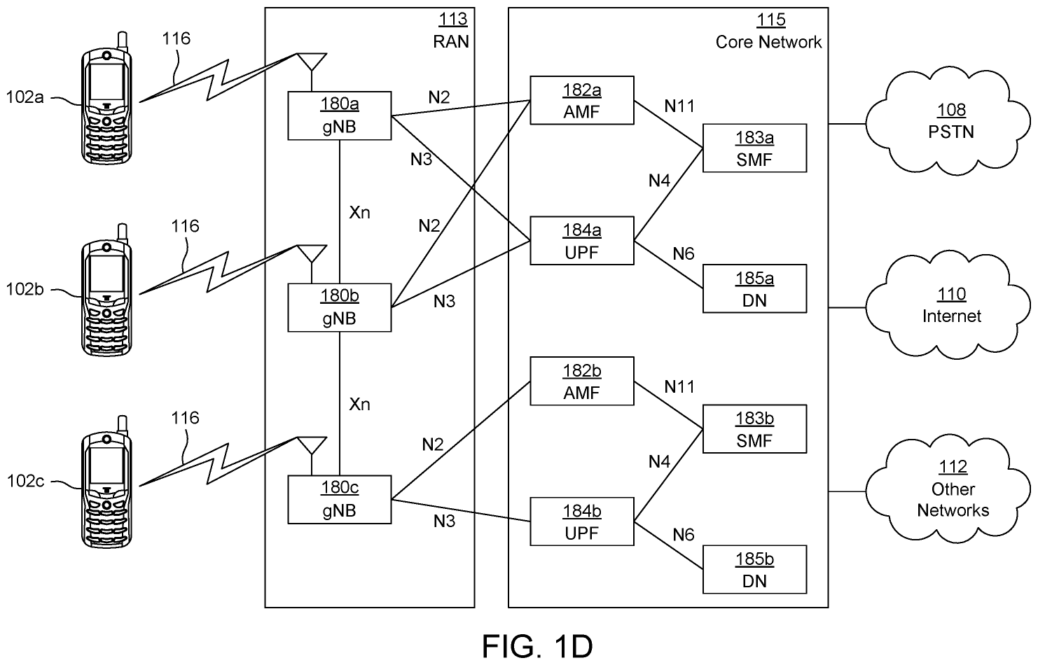

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHZ, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

### Blockchain Technology

Blockchain technology jointly leverages and builds on top of existing techniques such as cryptography, hashing, Merkle tree, distributed ledgers, peer-to-peer networking, and consensus protocols. Blockchain technology integrates them into a system (i.e. a blockchain system) that can provide advanced features such as decentralization, immutability, transparency, and security. Applications using and/or supported by a blockchain system are referred to as blockchain applications. A blockchain system is underpinned by blockchain networks composed of participating blockchain nodes. Each blockchain node hosts one or more distributed blockchains (i.e. a form of distributed ledgers) and participates in the blockchain system. For example, blockchain nodes can peer-to-peer networking to broadcast blockchain transactions and blocks among themselves. Blockchain nodes also perform consensus protocols to reach distributed trust without relying on a centralized party. A blockchain transaction can for example be a digital representation of a real-world transaction, a digital record of physical assets, a digital record of a physical event, a digital record of any action in an information system, a digital payment, and/or a digital smart contract. A block groups multiple blockchain transactions. A blockchain is a data structure chaining a growing number of blocks. Herein, blockchain technology is used as a non-limiting example of distributed ledger technology; the present principles can thus apply not only to any specific blockchain technology, but also to distributed ledger technology such as Permissioned Distributed Ledger [see ETSI GR PDL 003 V1.1.1 (2020-12); Permissioned Distributed Ledger (PDL); Application Scenarios].

The general workflow of a blockchain system includes five steps.
Step 1: Initiating Transactions. Each blockchain client or blockchain user generates new transactions independently. Each blockchain user has a user or account identifier, typically a hash of the user's public key that is used to sign the new transaction. The signed new transaction is then sent to the blockchain network.
Step 2: Broadcasting and Verifying Transactions. A new transaction is first received by a small number of blockchain nodes, which verify its integrity using the user's public key that is included in the transaction. If the validity of new transaction is successfully verified, the new transaction is relayed and broadcasted within the blockchain network. Eventually, all blockchain nodes will receive and have a copy of any newly generated, valid transaction.
Step 3: Building New Blocks. Specific building blockchain nodes (referred to as Mining Nodes or Full Blockchain Nodes) start to group a plurality of newly generated and pending transactions to generate a new block. The new block will include a block header and a block body. The block header generally includes a hash of the previously confirmed block, and a hash of all included transactions (e.g., Merkle tree). Dependent on the consensus protocol, the block header may contain additional information. The block body contains the content of all included transactions. Each building blockchain node independently attempts to create a new block.
Step 4: Validating New Blocks based on a Consensus Protocol. In step 3, building blockchain nodes independently attempted to create a new block. They run the same consensus protocol (e.g., Proof-of-Work in a Bitcoin system) and reach an agreement on who (i.e., a winner) is allowed to insert a block in the existing blockchain. The winner of the consensus protocol sends its newly generated block to the blockchain network. This new block is broadcasted and all building blockchain nodes receive and verify it.
Step 5: Updating Blockchain. After the newly generated block is verified in step 4, it is successfully appended to the existing blockchain, linked to it since it contains a hash of the previous block (i.e., the last block of the previous blockchain).

### AI Introduction

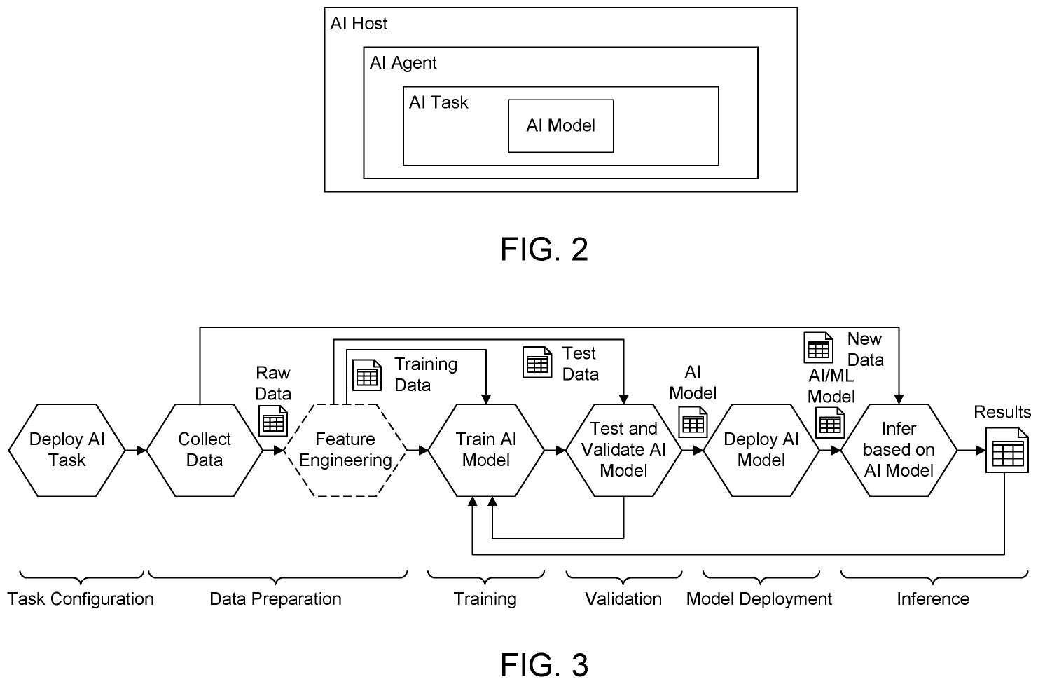

An AI system includes one or more AI agents, which learn and/or exploit an AI model based on at least one AI scheme such as deep learning, federated learning, and reinforcement learning. AI agents usually reside in different physical or logical nodes (e.g., devices, servers, a virtual machine in the cloud), referred to as AI Hosts (AIHs). Each AI agent usually hosts and runs an AI task, which for example is a task for learning an AI model according to an AI algorithm (e.g., a deep learning algorithm, a federated learning algorithm, a reinforcement learning algorithm) or a task for using an AI model to infer knowledge. Deep learning and reinforcement learning usually uses one AI agent, while federated learning utilizes multiple AI agents working collaboratively to learn an AI model, which could be a deep neural network model and a policy model for reinforcement learning. Federated learning can be used to solve various types of learning tasks including but not limited to deep learning and reinforcement learning. An AI algorithm could be supervised by relying on tagged training data or unsupervised without the use of any tagged data. FIG. 2 illustrates an AI host with an AI agent with an AI task using an AI model.

Herein, the process of (re-)installing an AI task (e.g., a piece of software code plus data) on an AI agent on an AI host is referred to as ‘AI task deployment’, while ‘AI model deployment’ refers to the process of transferring and/or (re-)installing an AI model to an existing AI task. Note that when an AI task has been deployed on an AI agent, AI agent and AI task may be used interchangeably in this description.

Herein, ‘model’ and ‘AI model’ are used interchangeably and mean the same thing unless explicitly stated; similarly, ‘task’ and ‘AI task’ are used interchangeably and mean the same thing unless explicitly stated.

FIG. 3 illustrates a general AI pipeline for supervised learning. The pipeline typically includes multiple stages: 1) Task configuration that includes the deployment of AI agents/tasks by an AI application or user; 2) Data preparation that includes data collection and, optionally, feature engineering/extraction; 3) Training for learning an AI model; 4) Validation for testing and validating the learned AI model; 5) Model deployment for deploying and transferring the validated AI model; and 6) Inference for inferring and predicting future knowledge using new data as input (referred to as input data for inference). The results (e.g. outcome) from the inference could be leveraged to action or trigger going back to training in order to re-train the AI model.

Depending on AI deployment choices, an AI agent could be: 1) an AI Agent for Learning (AIA4L) responsible for learning an AI model; 2) an AI Agent for Inference (AIA4I) using a learned AI model for inference and predication; and 3) an AI Agent for Learning and Inference (AIA4LI), combining the former two. AI model transfer generally occurs between an AIA4L and an AIA4I or between multiple AIA4LI.

### Deep Learning

Deep Learning (DL) is a specialized supervised machine learning (ML) that uses Deep Neural Networks (DNN) as is well known in the art. A DNN typically includes an input layer, multiple hidden layers, and an output layer. Each layer (in particular the hidden layers) has a number of artificial neurons, which are connected to neurons in the previous layer and to neurons in the next layer. A connection between two neurons in two neighboring layers is assigned a weight, which indicates to what extent the neuron in the prior layer will influence the neuron in the next layer. Training a DNN includes repeated feedforward and backpropagation.

Feedforward: input data passes through the DNN from the input layer to the output layer to generate an output (e.g., a scalar or a vector).

Backpropagation: the generated output is used to calculate a loss according to a pre-defined loss function. The loss is then used to adjust weights between two neighboring layers all the way backward from the output layer to the input layer, using gradient descent. The learned AI model in deep learning is the set of weights connecting all neurons in the DNN. A deep learning system can be deployed as one single AI agent (i.e., AIA4LI) or as multiple separate AI agents (e.g., one AIA4L and multiple AIA4I).

DNNs can provide a good approach for learning or approximating a non-linear function mapping input to output. However, data items used for training a DNN should have no or small correlations to achieve good performance (e.g., learning accuracy). DNNs can be used for solving many machine learning problems such as prediction and classification. Different types of DNNs have been designed for different applications. For example, Convolutional Neural Networks (CNNs) have been successful for computer vision and acoustic modeling, while Recurrent Neural Networks (RNNs) and Long Short-Term Memory (LSTM) are good tools for natural language processing.

### Federated Learning

Federated Learning (FL) is a framework for distributed ML or distributed AI. In FL, training data is maintained locally at multiple distributed Federated Learning Clients (FLCs) (e.g., mobile devices). Each FLC performs local training (e.g., deep learning), generates local model updates, and sends local model updates to a Federated Learning Server (FLS). The FLS, as a central entity, aggregates local model updates from FLCs and generates global model updates, which are sent to participating FLCs for the next training round. Example advantages of federated learning can include: 1) improved data privacy-preservation since training data stays at FLCs; 2) reduced communication overhead since it is not required to collect/transmit training data to a central entity; and 3) improved learning speed since model training now leverages distributed computation resources at FLCs. However, FL needs to transmit model updates between the FLS and FLCs, which introduces additional communication overhead compared to centralized machine learning. Also, FL requires data at all FLCs to follow an Independent and Identical Distribution (IID) (i.e., IID-data) to achieve good learning performance. In addition, FL inherits potential security issues and threats such as data poisoning and model poisoning attacks. In fact, the FLS hosts an FL agent for learning (i.e., AIA4L), while each FLC has an FL agent that could be for both learning and inferring (i.e., AIA4LI). Note that both FLS and FLCs are AIHs.

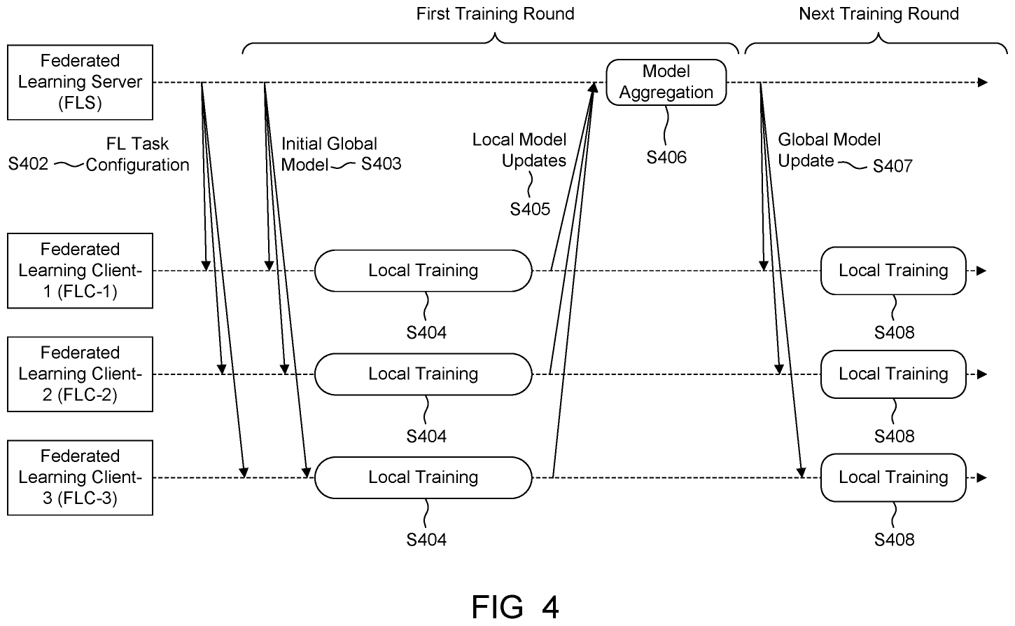

FIG. 4 illustrates the general Federated Learning process, where, for example, the FLS could be an NWDAF in 5G and FLCs could be UEs. The FLS and FLCs jointly take the following steps to perform an FL task.
Step S401 (not illustrated): The FLS selects a set of FLCs to participate in a FL task. In the illustrated example, FLCs 1-3 are selected.
Step S402: The FLS configures (e.g., deploys or instructs the FLCs to start local training of an already deployed FL task) the FL task to each selected FLC.
Step S403: The FLS sends an initial global model to each selected FLC.
Step S404: Each FLC independently trains the global model based on the received initial global model and its local data.
Step S405: After the local training round in step S404, each FLC generates a local model update that it sends to the FLS.
Step S406: The FLS receives local model updates from the selected FLCs, aggregates them, and generates a global model update. In synchronous FL, the FLS waits until it has received local model updates from all participating FLCs before performing the aggregation. In asynchronous FL, the FLS can start the aggregation upon reception of the local model updates from a subset of participating FLCs.
Step S407 is similar to step S403, but the FLS sends the global model updates to selected FLCs. It is noted that the FLS can change the set of selected FLCs between training rounds, for example retaining one or more FLCs of the previous set.
Step S408 is similar to Step S404, i.e. the selected FLCs independently trains the global model based on the received global model update.
Step S409 (not illustrated) is similar to step S405: the FLCs send local model updates to the FLS. The FLS can then generate a new global model update, which the FLS can send to FLCs as the beginning of a further iteration.

### AI-Related 3GPP Standards

3GPP TS 22.261 [3GPP TS 22.261 V18.5.0 (2021-12); Service requirements for the 5G system; Stage 1 (Release 18)] specifies AI model transfer requirements for three types of AI operations: 1) AI operation splitting between AI endpoints; 2) AI model/data distribution and sharing over 5G system (5GS); and 3) distributed/federated learning (FL) over 5GS.

3GPP TR23.700-80 [3GPP TR 23.700-80 v0.3.0 (2022-05) Study on 5G system support for AI-based services (Release 18)] aims to define intelligent transmission support for AI-based services in 5GS. It will focus on 5GS architectural and functional extensions so that service providers can leverage 5GS as the intelligent transmission platform to support AI-based services.

TR 23.700-80 has a number of main objectives: study the possible architectural and functional extensions to support the application-layer AI operations defined in TS 22.261; study possible QoS, policy enhancements to support Application AI operational traffic while supporting regular (non-Application-AI) 5GS user traffic; and study whether and how 5GS provides assistance to an AF and the UE for the AF and UE to manage the FL operations and model distribution/redistribution (e.g., FL members selection) to facilitate collaborative application AI based on Federated Learning operations between the application clients running on the UEs (i.e., FLCs) and the Application Servers (i.e., the FLS).

In addition, 3GPP recently approved a new release-19 study item [3GPP SA1 S1-220183, “Study on AI Model Transfer Phase2,” 3GPP SA WG1 Meeting #97-e, Feb. 14-24, 2022] to study the use cases and potential service and performance requirements for distributed AI training/inference involving direct device connection, which has the following two objectives: Distributed AI training/inference based on device-to-device connection; and Charging and security aspects.

### ETSI SAI

ETSI GR SAI 0010 [ETSI GR SAI 0010 V0.0.1 (2022-01); Securing Artificial Intelligence (SAI); Traceability of AI Models] aims to study the role of AI traceability in securing AI and exploring the potential issues related to sharing and re-using models across different tasks or various industry-related applications. The scope of AI traceability includes, but is not limited to, discovering potential threats, and their associated remediations. Further AI traceability can improve the decisions to where AI traceability would be applicable, protect ownership rights of AI creators as well as to protect origin of the model verification, ensure the model integrity, or discover its purpose.

### Wireless AI Use Cases

Two wireless AI use cases are described, including Deep Learning (DL) in wireless networks and federated learning for wireless networks. In both use cases, there is a need to deploy AI tasks (i.e., deep learning and federated learning) and AI models from an edge data network (or core network) to wireless devices. As ETSI GR SAI 0010 shows, it can be important to provide traceability to the deployed AI tasks and AI models, which requires AI tasks and AI models to be traced during their lifecycle, which can be leveraged as the foundation to build auditable, explainable, and trustworthy AI.

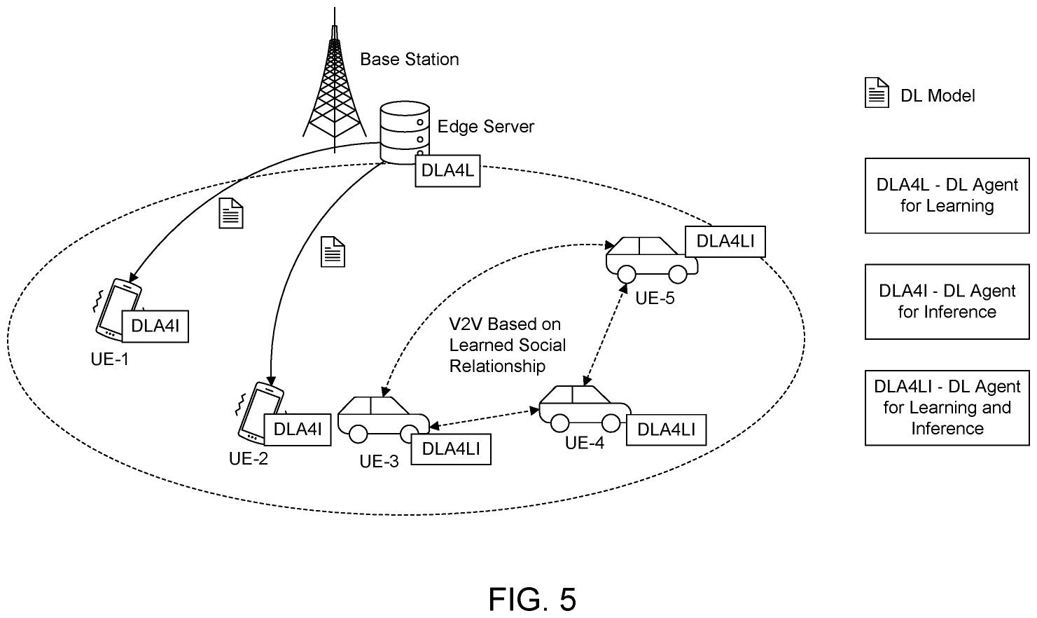

FIG. 5 illustrates two examples of DL applications for wireless networks, where a UE hosts a DL agent, which hosts an AI task. The AI task uses a DL model, learns a DL model, or both. The DL agent at each UE is pre-installed or run-time deployed. Note that in FIG. 5, DL could be replaced with another type of AI algorithm. In this use case, the base station and each UE is an AIH.

DL for Radio Resource Allocation: DL is used to learn radio resource allocation between UE-1 and a base station. For example, a DL agent (i.e., DLA4L) is deployed in an edge server co-located with the base station. The DL agent is configured with an AI task to learn radio resource allocation policy. Based on historical transmission information about UE-1 (and/or other UEs) and the base station, the DL agent learns a model for allocating radio resource for UE-1 (and/or UE-2). Then the learned model is deployed to UE-1 (and/or UE-2). At each new time slot, the DL agent at UE-1 and/or UE-2 (i.e., DLA4I) can use the model to decide on new radio resources for upstream transmission. Such an AI-based approach could capture wireless channel dynamics and the changing traffic over a wireless channel more quickly and accurately, and in turn lead to improved radio resource utilization.

DL for Vehicle-to-Vehicle Content Dissemination: Three vehicles (i.e., UE-3, UE-4, and UE-5) are within the same vicinity and can communicate with each other directly for sharing content (e.g., a media file). To disseminate content more efficiently, each vehicle is installed with a DL agent (i.e., DLA4LI) to, for example, learn social relationships and content popularity.

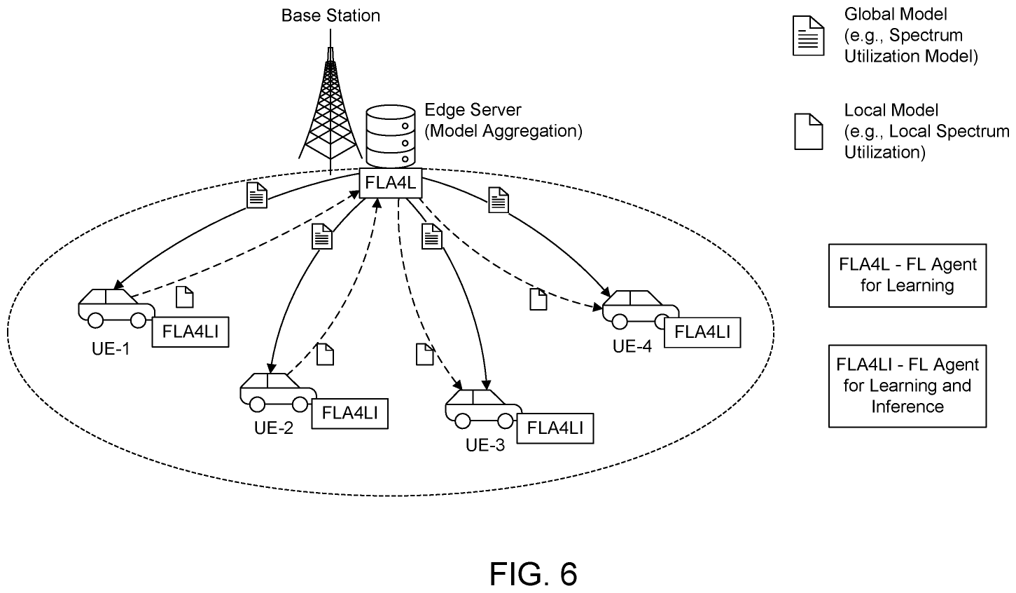

FIG. 6 illustrates an example of a FL application for wireless networks, where each UE hosts an FL agent, which collaboratively participates in learning a global model and uses the learned global model for inference. The FL agent at each UE is pre-installed or deployed at run-time. In this case, each UE and the edge server is an AIH.

FL for Spectrum Management: FL is used to learn an accurate spectrum utilization model. Each UE (i.e., UE-1, UE-2, UE-3, and UE-4) hosts an FL agent (i.e., FLA4LI), which acts as an FLC to generate a local model update. Local model updates are sent to an edge server, which has an FL agent (i.e., FLA4L) mainly responsible for aggregating local model updates from UEs to generate a global model update. The global model update is sent to the UEs to continue the next training round until the global model converges. Then, the converged final global model is transmitted to the FL agent at each UE, and each UE uses the FL agent with the final global model to manage its local spectrum access.

In the aforementioned AI use cases for wireless networks, a UE usually hosts an AI agent (e.g., AIA4L, AIA4I, or AIA4LI), which learns a model, uses a model for knowledge inference, or participates in both. To deploy a particular AI scheme for wireless networks, AI agents (e.g., a piece of software) first need to be installed on corresponding UEs and/or other network nodes such as edge servers. Then, an AI agent starts to train an AI model, which may demand the collection of training data. After the AI model is trained the AI agent typically tests and validate the AI model against test data and validation data, before the AI model is deployed (e.g., transfer the AI model from one AI agent to another AI agent). Finally, the deployed or transferred AI model can be used to infer and predict future knowledge and take action from real data.

It is envisioned that future wireless systems will have native-AI functionalities. In other words, AI agents/tasks/models will be an integral part of future wireless systems, for instance, deployed at different networking nodes as a service to support various applications as illustrated in wireless AI use cases. In the meantime, the wireless AI use cases also demonstrate the following characteristics of native AI in future wireless systems: 1) there are different types of AI agents/tasks/models; 2) decentralized AI agents/tasks/models exist in UEs; 3) AI-enabled wireless applications are diverse; 4) an AI agent/task/model may be able to support multiple wireless applications; 5) a wireless application may need to use multiple applications; and 6) wireless applications may need different AI agents/tasks/models at different time and/or under different circumstances (e.g., location).

To coordinate efficiently between wireless applications and AI agents/tasks/models, a standardized AI enablement layer can be required, especially to consider these characteristics in wireless AI use cases. As a result, interactions between wireless applications and AI agents/tasks/models could be more efficient. For example, a wireless application can rely on this AI enablement layer to find appropriate AI models easily. This AI enablement layer aims to provide some common functionalities and services for both wireless applications and AI agents/tasks/models. On one hand, wireless applications leverage these services to access AI agents/tasks/models, on the other hand, AI agents/tasks/models can expose themselves to and be managed by the AI enablement layer. However, there is no such standardized AI enablement layer in 3GPP.

Hence, an AI enablement layer that considers unique characteristics in wireless AI use cases could provide common services, for example in the following cases.

AI Application Management: Before an AI Application (AIAPP) can use the common services provided by the AI enablement layer, the AIAPP is registered and authenticated with the AI enablement layer. Dependent on whether the AIAPP is hosted by a UE or simply a network application, different registration process may be needed.

AI Agent Management: An AI Agent (AIA) relies on the AI enablement layer so that it can be accessed and interacted with other AIAs and/or AIAPPs. An AIA may be deployed by the AI enablement layer. Alternatively, an existing AIA can be registered with and managed by the AI enablement layer.

AI Task Management: The AI enablement layer can coordinate the deployment of an AI task to an AIA, by matching AI requirements of the AI task to AI capability of the AIA. The AI enablement can also facilitate the migration of a deployed AI task from one AIA to another AIA.

AI Model Management: The AI enablement layer also needs to manage AI models. To enable efficient AI model sharing and transfer among different entities (e.g., AIAPPs, AIAs), the AI enablement layer can maintain an AI model repository to record any available AI models. The AI enablement layer can also use the AI model repository to provide services for AI model discovery and deployment.

The present principles provide two AI enabler service architectures, which include two new entities: AI Enabler Client (AIEC) and AI Enabler Server (AIES). Very generally, the AIEC registers itself to the AIES and uses services provided by the AIES. The proposed AI Enabler service architecture can provide the following. the following main ideas are proposed:

For AI Application Management, an AI Application (AIAPP) on a UE can register itself to an AIES indirectly via a local AIEC. The AIAPP can also just register itself to the local AIEC. The AIES and/or the local AIEC creates an AIAPP record for each registered AIAPP and stores the record in an AIAPP repository. An AIAPP in the network registers itself directly to an AIES.

For AI Agent Management, an AI Agent (AIA) can register itself including its AI capability and AI tasks to an AIES indirectly via a local AIEC. The AIA can also just register itself to the local AIEC. The AIES and/or the local AIEC creates an AIA record for each registered AIA and stores the record in an AIA repository. The AIES exposes the AIA repository to other entities to discover any appropriate AIAs.

For AI Task Management, the AIES facilitates an AIAPP (and/or other entities) to deploy an AI task to an appropriate AIA. The AIES may help to find the appropriate AIA from its AIA repository. For deploying the AI task to the AIA, the AIES also finds the corresponding AIEC, which interacts with the AIES on behalf of the AIA. Finally, the AIES sends the AI task to the AIA via the corresponding AIEC. The AIES may find a new AIEC and a new AIA to migrate the AI task from previous AIEC/AIA to new AIEC/AIA. The AIES maintains an AI task repository to record each deployed AI task.

For AI Model Management, after an AIA has trained an AI model, the AIA can register the AI model to an AIES via its AIEC. The AIEC can designate some model usage constrains on the AI model on behalf of the AIA. The AIES maintains an AI model repository to store all registered AI models, which can then be discovered by and deployed to other entities such as AIAs that use an AI model to infer knowledge.

The following terms are defined as follows:
AI Model: the learned model (e.g., a set of parameters) from training data, which can accurately capture or model patterns in the training data.
AI Task: a task for training an AI model and/or using a trained AI model. An AI task can be deployed to an AI host as a piece of software with some relevant information (e.g., an initial AI model, training data, and/or input data).
AI Agent: an entity with the capability to run an AI task. An AI agent is hosted by an AI host, while an AI host can host multiple AI agents. An AI agent can produce/train an AI model and/or use a trained AI model to infer knowledge.
AI Host: an entity with both software and hardware to support one or multiple AI agents.
AI Pipeline: a set of stages for executing one or multiple AI tasks for a goal. An AI pipeline may consist of task configuration stage, data preparation stage, training stage for learning an AI model, validation stage for testing and validating the learned AI model, model deployment stage for deploying and transferring the validated AI model, and inference stage for inferring and predicting future knowledge using new data as inputs.
Distributed Storage System: the system that stores information (e.g., the information about an AI model, the information about an AI host, training data, inferred knowledge, etc.). DSS could be distributed database, distributed ledgers, blockchain system, etc.
AI Application (AIAPP): an application entity that leverages AI functionalities provided by an AI enabler server and/or AI agents.
AI Enabler Server (AIES): an entity that coordinates the interaction between AI applications and AI hosts including AI agents. An AIES provides services to AI applications. The AIES interacts and manages AI agents via one or multiple AI enabler client.
AI Enabler Client (AIEC): an entity that interacts with an AIES on behalf of AI agents. An AIEC may reside in a standalone AI host or be co-located with AI agents within the same AI host.

Herein, the identifier or the address of an entity can refer to, but is not limited to, one or multiple of the following information items:
Endpoint of the entity for communication (e.g., URI, FQDN, IP Address, etc.)
Transport information of the entity such as the type of protocol (e.g., REST/HTTP, CoAP, Topic-based, Pub Sub, RPC, WebSocket, etc.), security-related information (e.g., security credential, certificates, public keys, etc.), version, etc.
Blockchain address of the entity (e.g., hash value of a public key).

### AI Enabler Service Architecture

### Basic AI Enabler Service Architecture

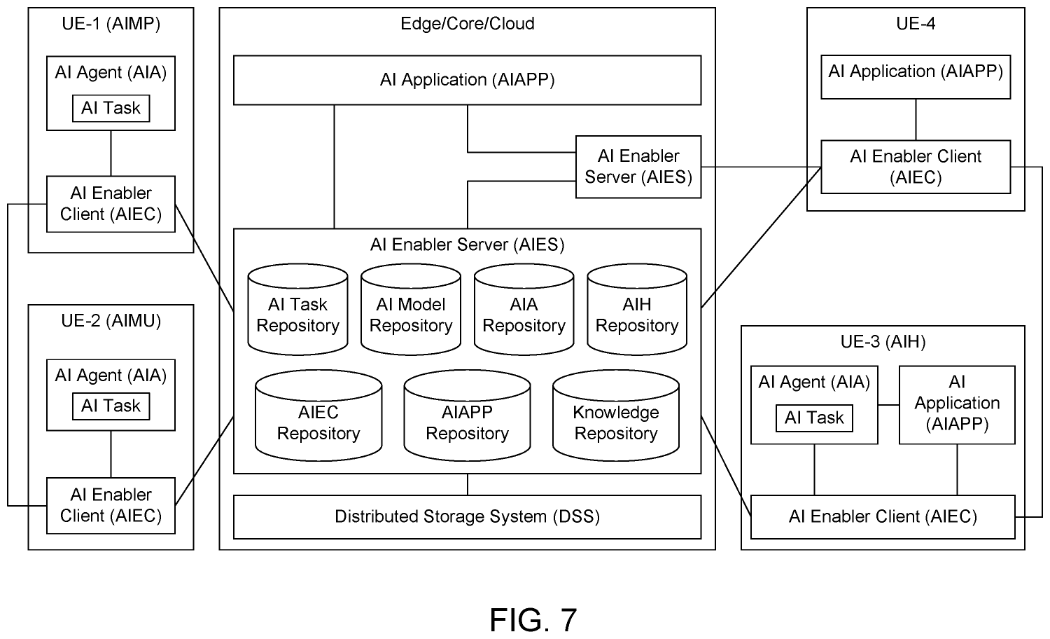

FIG. 7 illustrates an AI enabler service architecture according to a first embodiment of the present principles, the AI enabler service architecture primarily including an AI enablement layer. This architecture contains a set of logical entities including AI Enabler Server (AIES), AI Enabler Client (AIEC), Distributed Storage System (DSS), AI Application (AIAPP), and AI Agent (AIA). Note that an AI Agent could be an AI Agent for Learning (AIA4L) hosted by an AIMP and/or an AI Agent for Inferring (AIA4I) hosted by an AIMU. In addition, an AI Host (AIH) could be an AI Model Producer (AIMP) such as UE having an AIA4L and/or an AI Model User (AIMU) such as a UE with an AIA4I. In this architecture, AIES and AIEC essentially form an AI enablement layer, which provides AI management and services to AIAPPs and AIAs.

AI Enabler Server (AIES): An AIES may maintain six repositories: an AI task repository, an AI model repository, an AIA repository, an AIH repository, an AIEC repository, an AIAPP repository, and a knowledge repository. The repositories can be accessed by AIECs and/or AIAPPs in edge/core/cloud. An AIAPP on a UE can also indirectly access those repositories via an AIEC on the same UE. An AIES can interface to another AIES to exchange any information stored in their repositories.

The AI task repository stores AI tasks that have been deployed and/or are to be deployed to AIHs. For example, an AIAPP in edge/core/cloud can discover an AI task from the AI task repository and trigger the AIES to install the discovered AI task to an AIA at a UE.

The AI model repository stores AI models that have been generated, have been deployed, and/or are to be deployed to AIHs. For example, an AIAPP at UE-3 (or the AIAPP in edge/core/cloud) can discover an AI model from the AI model repository and trigger the AIES to install the discovered AI task to the AIA at UE-3. In addition, when the AIA at UE-1 generates a new AI model, it can submit and register the new AI model to the AI model repository.

The AIA repository stores a list of AIAs, which have been registered to the AIES. An AIA needs to be registered with the AIES, before an AI task and/or an AI model can be installed to the AIA or before the AIA can register a new AI model to the AIES.

The AIH repository stores a list of AIHs. When an AIEC (or an AIA, an AIAPP) registers itself to an AIES, the corresponding AIH hosting the AIEC (or the AIA, the AIAPP) will be registered to the AIES too. As a result, the AIES maintains all registered AIHs.

The AIEC repository stores a list of AIECs, which have been registered to the AIES. An AIEC at a UE registers itself to the AIES so that it can use services provided by the AIES. After the AIEC registers itself to the AIES, the AIES creates a new AIEC registration record in the AIEC repository.

The AIAPP repository stores a list of AIAPPs, which have been registered to the AIES. An AIAPP needs to register itself to the AIES, before it can leverage services provided by the AIES. For example, the AIAPP in edge/core/cloud first registers itself with the AIES before it can request the AIES to install an AI task to an AIA.

The knowledge repository stores knowledge as inferred and reported by AIAs. When an AIA (specifically, an AIA4I) infers or derives some knowledge from an AI model, it can submit the knowledge to the AIES, which stores it to the knowledge repository and makes it accessible for other AIAs and/or AIAPPs.

AI Enabler Client (AIEC): AIEC provides services to AIAs and AIAPPs to facilitate their interaction with the AIES. An AIEC is an intermediary party or proxy between AIAs and the AIES, and between AIAPPs and the AIES. For example, when an AIA at UE-1 needs to register a new AI model to the AIES, it sends the new AI model to the AIEC, which then forwards the AI model to the AIES. In another example, when the AIAPP at UE-4 requests the AIES to install an AI task to an AIA at UE-1, the AIAPP sends such a request to the AIEC at UE-4, which then forwards the request to the AIES. The AIES receives the request and finds an appropriate AI task. The AIES sends the AI tasks including its software code to the AIEC at UE-1, which passes the AI task to the AIA at UE-1. Each UE will have at least one AIEC, which can support one or multiple AIAs and/or AIAPPs at the same UE. AIECs at different UEs may communicate with each other to enable for more direct and efficient AI-related interaction between two UEs (e.g., direct model and/or knowledge transfer from one UE to another UE).

AI Agent (AIA): AIA runs an AI task to produce an AI model and/or infer some knowledge based on an AI model. An AIA is hosted by a UE. Alternatively, AIAs can be hosted in edge/core/cloud. The AIA at a UE directly interfaces with a local AIEC, which facilitates the AIA to interact other entities in edge/core/cloud and/or at other UEs. Using UE-3 as an example, the AIAPP at UE-3 may instruct the local AIA directly (e.g., feed training data to the AIA, stop or resume tracing AIA, stop or resume AI learning or inferring process at the AIA, retrieve the inferred knowledge from the AIA).

AI Application (AIAPP): AIAPP may exist in edge/core/cloud or at UE. The AIAPP in edge/core/cloud interacts with the AIES directly, for example, to request installation of an AI task to an AIA, to request installation of an AI model to an AIA, to request retrieval of an AI model from an AIA, to request to retrieve inferred knowledge from an AIA, etc. The AIAPP in edge/core/cloud can also directly access those repositories maintained at the AIES. An AIAPP at a UE can make the similar requests to the AIES, but those requests are processed and forwarded to the AIES by the local AIEC at the same UE. An AIAPP at a UE can directly interact with local AIAs at the same UE (e.g., UE-3).

### Blockchain-Based AI Enabler Service Architecture

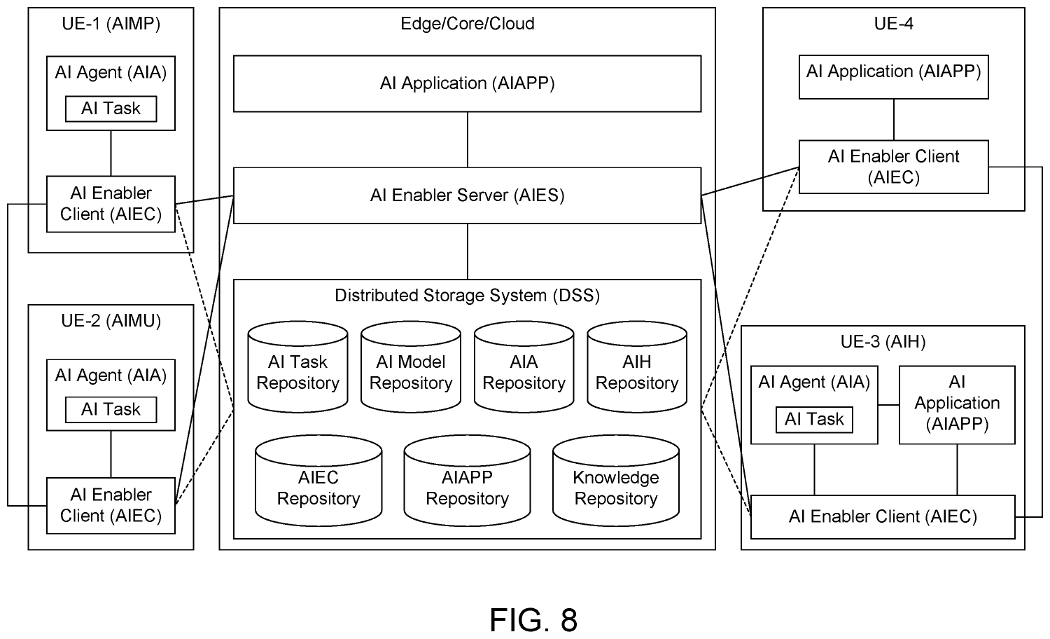

FIG. 8 illustrates an AI enabler service architecture according to a second embodiment of the present principles. In this architecture, the seven repositories are maintained within a DSS (e.g., a distributed ledger). Each record in the repositories could be created by an AIES and/or by an AIEC. The AIES may simply publish the information about itself, any AIEC, any AIA, any AIAPP, any AI task, any produced model, and/or any produced knowledge to the DSS. This publication process may be fully transparent to AIECs and, in this case, ALECs do not interact with the AIES.

As an alternative, the AIES can also enable AIECs to directly interact with the DSS. The AIES may first configure each AIEC with the address and any access-related information of the DSS (e.g., the address of one or multiple distributed ledger nodes, the distributed ledger protocol specifications such as how to join the distributed ledger system and how to create and send a transaction to the distributed ledger systems such as tip selection policy in IoTA system). Once an AIEC receives such DSS information, the AIEC can directly publish any information about itself, the AIA, the AI task hosted by the AIA, the AIAPP, any produced model, and/or any produced knowledge to the DSS. The AIEC can also directly look up and search the information about other AIECs from the DSS and those repositories. After the AIEC discovers such information, the AIEC can forward the discovered information to the AIES.

### AIAPP Management

### Indirect AIAPP Registration

An AIAPP on a UE can register itself to an AIES indirectly via an AIEC on the same UE (or on a different UE).

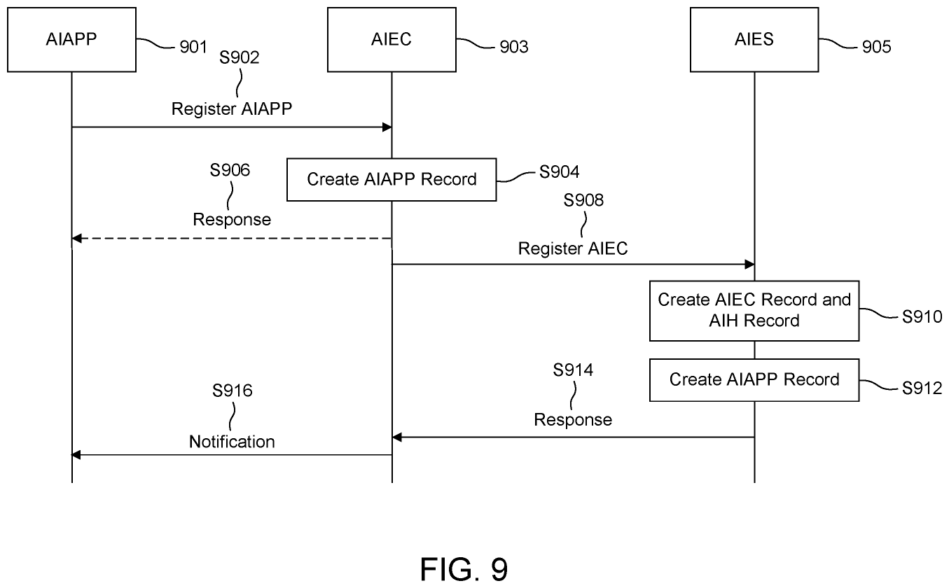

FIG. 9 illustrates a method of indirect AIAPP registration according to an embodiment.

In step S902, an AI Application (AIAPP) 901 sends a request to an AI Enabler Client (AIEC) 903 to register itself. This AIAPP registration request may include:
AIAPP-Type: the type or the purpose of this AIAPP (e.g., to discover and/or deploy an AI task, to discover and/or deploy an AI model, to discover any inferred knowledge, etc.).
AIAPP-ID: the identifier and/or the address of the AIAPP.
UE-ID: the identifier and/or the address of the UE which hosts the AIAPP.
AI-Task-List: a list of AI tasks including their task identifier (i.e., AI-Task-ID) and their task type (i.e., AI-Task-Type) that the AIAPP would like to deploy in future to some AIAs.
AIAPP-Registration-Type: an indicator if the request is for a local registration with the AIEC or a remote registration with an AIES.
AIES-ID: the identifier or the address of the AIES for the remote registration. It is noted that AIES-ID is optional even for the remote registration. In many cases, the AIAPP and the AIEC are hosted at the same UE.

It is noted that AI-Task-Type could indicate if the corresponding task is for training a model, inferring knowledge, or both. AI-Task-Type could also indicate if the corresponding AI task is a DL task, a FL task, RL task, or other kinds. AI-Task-Type could also indicate the purpose of the corresponding AI task (e.g., regression, classification, clustering, etc.). AI-Task-Type could also indicate the application category of the corresponding AI task (e.g., natural language processing, text processing, image processing, video processing, etc.)

The AIEC 903 receives the AIAPP registration request. The AIEC 903 then authenticates the registration request, especially when the registration request is from another UE and it contains the identifier of that UE (i.e., UE-ID).

It is noted that the AIEC 903 may have been provided a list of allowable UEs, for example, by an AIES 905. Then, the AIEC 903 simply checks if UE-ID contained in the AIAPP registration request is on this list. If it is on the list, the authentication passes and, as a result, the AIEC 903 may assign a unique identifier to the AIAPP 901, referred to as AIAPP-ID.

If the AIEC 903 cannot authenticate the AIAPP by itself, it may use the Register AIEC message (see step S908) to pass UE-ID and/or other parameters received from the AIAPP 901 in step S902 to an AIES 905, which will help the AIES 905 to authenticate the AIAPP 901.

In step S904, the AIEC 903 may create a local AIAPP record for the registered AIAPP 901, especially when the AIAPP requested local registration in the request in step S902. This local AIAPP record may include AIAPP-Type, AIAPP-ID, UE-ID, registration time, and/or other parameters as received in the request.

In step S906, the AIEC 903 can send a response to the AIAPP 901, especially when the AIAPP 901 requested local registration with the AIEC 903. This response message may include contain AIAPP-ID.

Alternatively, the response may be sent to the AIAPP 901 as a quick acknowledgement of the reception of the request message, for example including no AIAPP-ID. In this case, AIAPP-ID is included will be sent to the AIAPP 901 in a later notification (see step S916).

However, in case the response includes AIAPP-ID, the notification in step S916 can be omitted; indeed, the whole step may then be skipped.

In step S908, the AIEC 903 sends a request to the AIES 905 to register itself and one or multiple AIAPPs. It is assumed that the AIEC 903 is hosted by a UE (i.e., an AIH). It is also assumed that the AIEC 903 has been provisioned with or has discovered the address of the AIES 905. Note that the AIEC 903 may also receive the AIES 905 address from the request in step S902. This registration request may include:
AIH-ID: identifier or the address of the AIH that hosts the AIEC. If AIH is a blockchain node or a blockchain user, its blockchain address (e.g., a unique identifier generated from its public key) can be used as an AIH-ID.
AIH-Type: indicates if the AIH is an AIMP, an AIMU, or both.
AIH-AI-Capability: the capability and affordable resources that the AIH can allocate for hosting AI agents/tasks. This parameter could indicate but is not limited to: 1) Computing resource budget for running AI tasks; 2) Storage resource budget for running AI tasks; 3) Training data properties such as the number of data samples and the number of features in a data sample; and 4) Input data properties (used for knowledge inference) such as the number of data samples and the number of features in a data sample. In case the AIH already hosts an AI task, AI-Capability can indicate additional information about the AI task including but not limited to: 1) the unique identifier of the hosted AI task (AI-Task-ID); 2) the type of the hosted AI task (AI-Task-Type); and 3) the address for accessing/managing the AI model of the AI task.
AIEC-ID: the address or a temporary identifier of the AIEC.
Requested-Service-List: indicate a list of services the AIEC would like to request (e.g., service for accessing the AI task repository, service for accessing the AI model repository, service for discovering an AIA via the AIES, service for tracing an AI task and/or an AI model via the AIES, etc.).
AIAPP-List: a list of AIAPPs and their UE-ID that have been sent via the AIAPP registration request to the AIEC (e.g., as in step S902). Each item in AIAPP-List may also include parameters as received in the request in step S902. Alternatively, each item in AIAPP-List may correspond to an AIAPP record as created in step S904. Each item in AIAPP-List may include an AIAPP registration flag (AIAPP-Registration-Flag) to indicate whether the corresponding AIAPP needs to be registered with the AIES and/or the AIEC needs the AIES to authenticate this AIAPP; for example, if AIAPP-Registration-Flag is TRUE, the corresponding AIAPP shall be registered with the AIES and/or the AIES shall authenticate this AIAPP. AIAPP-Registration-Flag can be derived from AIAPP-Registration-Type from request in step S902.

In case the AIAPP 901 requested local registration with the AIEC 903, the AIEC 903 can still include this AIAPP 901 in this request to simply report the AIAPP 901 to the AIES 905.

In step S910, the AIES 905 receives the registration request from the AIEC 903. It authenticates the AIEC 903 and approves the services to be allocated to the AIEC, for example, based on preconfigured policies. The AIES 905 may approve one or multiple services as requested in Requested-Service-List. All approved services are contained in Approved-Service-List. The AIES 905 may (re) assign a unique identifier for the AIEC 903, referred to as AIEC-ID. The AIES 905 may create a new AIEC record for the registered AIEC 903, which may include AIEC-ID, Approved-Service-List, and/or other parameters received in the request in step S908. This new AIEC record will be added to the AIEC repository. The AIES 905 may create a new AIH record if AIH-ID was received in the request. This AI record includes AIH-ID, AIH-Type, and AIH-AI-Capability as included in the request in step S908. This new AIH record is stored in the AIH repository.

In case the AIAPP-List was received in step S908, and especially when the AIEC 903 needs the AIES 905 to authenticate one or more AIAPP 901 (e.g., AIAPP-Registration-Flag is TRUE), the AIES 905 may authenticate each AIAPP 901 and their UE-ID if the AIAPP 901 is hosted at a different UE, for example, based on preconfigured policies. A policy may specify that a UE-ID cannot host more than a certain number of AIAPPs. In case the authentication passes (i.e., positive authentication), the AIES 905 may (re) assign AIAPP-ID for each AIAPP 901. Then, in step S912, the AIES 905 may create a new AIAPP record for each authenticated AIAPP 901, which may include AIAPP-ID and/or other parameters that are contained in AIAPP-List and related to this AIAPP. This new AIAPP record will be added to the AIAPP repository.

In step S914, the AIES 905 sends a response message to the AIEC 903. This response message may include:
AIEC-ID: assigned in step S910.
Approved-Service-List: determined in step S910.
Approved-AIAPP-List: a list of AIAPPs approved in step S912.

The AIEC 903 receives the response message from the AIES 905. The AIEC 903 extracts Approved-AIAPP-List to determine which AIAPP 901 has been approved. Then, the AIEC 903 creates (e.g., generates) a new notification message for each approved AIAPP 901 whose AIAPP-ID is included in Approved-AIAPP-List. In step S916, the AIEC 903 sends the new notification to each approved AIAPP 901.

Among the options to the implementation of the method illustrated in FIG. 9 are: 1) Use steps S902-S906 to register an AIAPP 901 to an AIEC 903; 2) Use steps S902-S904 and S908-S916 to register an AIAPP 901 to an AIEC 903 and/or an AIES 905; 3) Use steps S908, S910 and S914 to register an AIEC 903 to an AIES 905; and 4) Use steps S908-S914 to register an AIEC 903 plus its AIAPPs 901 to an AIES 905.

### Direct AIAPP Registration

An AIAPP can register itself to an AIES directly without involving an AIEC as in FIG. 9.

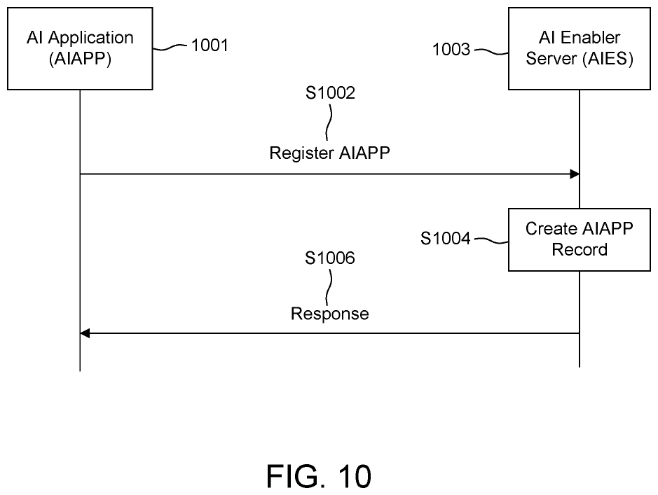

FIG. 10 illustrates a method of direct AIAPP registration according to an embodiment of the present principles.

In step S1002, an AI Application (AIAPP) 1001 sends a request to an AIES 1003 to register itself. This AIAPP registration request may for example include:
AIAPP-Type: the type or the purpose of this AIAPP (e.g., to discover and/or deploy an AI task, to discover and/or deploy an AI model, to discover any inferred knowledge, etc.).
AIAPP-ID: the identifier and/or the address of the AIAPP.
UE-ID: the identifier and/or the address of the UE which hosts the AIAPP.
AI-Task-List: a list of AI tasks including their task identifier (i.e., AI-Task-ID) and their task type (i.e., AI-Task-Type) that the AIAPP would like to deploy in future to some AIAs.

In step S1004, the AIES 1003 may authenticate the AIAPP 1001 and its UE-ID if the AIAPP is hosted at a different UE, for example, based on some preconfigured policies. A policy may specify that a UE-ID cannot host more than a certain number of AIAPPs. If the authentication passes, the AIES may (re) assign AIAPP-ID for the AIAPP 1001. Then, it may create a new AIAPP record for the authenticated AIAPP, which may consist of AIAPP-ID and/or other parameters that are contained in AIAPP-List and related to this AIAPP. This new AIAPP record will be added to the AIAPP repository.

In step S1006, the AIES 1003 sends a response message to the AIAPP 1001. The response message may include:
AIAPP-ID as assigned in step S1004.
Approved-Service-List as determined in step S1004.

### AI Agent Management

### AI Agent Registration

An AIA can need to register itself to an AIEC and/or an AIES, regardless of whether or not AIA and the AIEC are co-located within the same UE or other node. In many cases, the AIA and the AIEC are hosted at the same UE.

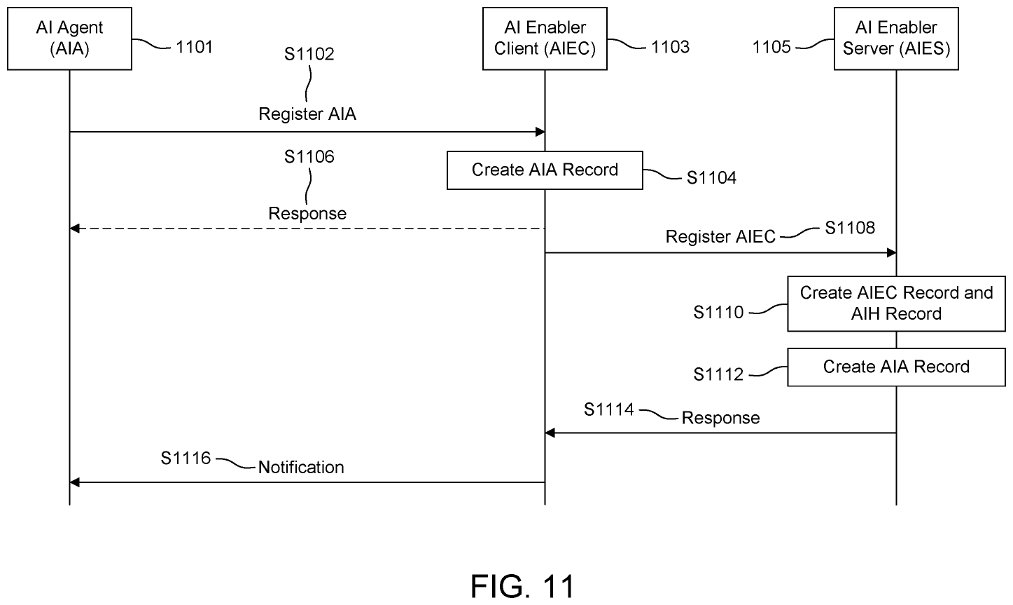

FIG. 11 illustrates a method of AIA registration according to an embodiment of the present principles.

In step S1102, an AIA 1101 sends a registration request to an AIEC 1103 to register itself. This registration request may include:
AIA-Type: the type of the AIA (i.e., an AIA4L, an AIA4I, or an AIA4LI).
AIA-AI-Capability: the AI capability of this AIA. This could indicate, but is not limited to: 1) Computing resource budget for the AIA; 2) Storage resource budget for the AIA; 3) Training data properties such as the number of data samples and the number of features in a data sample; and 4) Input data properties (used for knowledge inference) such as the number of data samples and the number of features in a data sample. In case the AIA already hosts an AI task, AI-Capability can indicate additional information including but not limited to: 1) the unique identifier of the hosted AI task (AI-Task-ID); 2) the type of the hosted AI task (AI-Task-Type); and 3) the address for accessing/managing the AI model of the AI task.
AIA-Registration-Type: indicates if the registration request is for local registration with the AIEC or remote registration with an AIES.
UE-ID: the identifier of the UE that hosts the AIA.
AIES-ID: the identifier or the address of the AIES for the remote registration. It is noted that AIES-ID is optional even for the remote registration.

The AIEC 1103 receives the AIA registration request. The AIEC 1103 authenticates the registration request, especially when the registration request is from another UE and includes the identifier of this UE (i.e., UE-ID).

The AIEC 1103 may have been provided a list of allowable UEs, for example, by an AIES 1105. Then, the AIEC 1103 can check if UE-ID included in the registration request is on this list of allowable UEs. In case UE-ID is on the list, the authentication passes.

In case the registration request is authenticated, the AIEC 1103 may assign a unique identifier for the AIA 1101, referred to as AIA-ID. In case the AIEC 1103 cannot authenticate the AIA 1101 by itself, the AIEC 1103 may pass the UE-ID and/or other received information to an AIES 1105 in a registration message (see step S1108), which will help the AIES 1105 authenticate the AIA 1101.

In step S1104, the AIEC 1103 may create a local AIA record for the registered AIA 1101, especially when the AIA 1101 requested local registration. This local AIA record may include of AIA-ID, UE-ID, registration time, and/or other information received in the AIA registration request.

In step S1106, the AIEC 1103 may send a response message to the AIA 1101, especially when the AIA 1101 requested local registration with the AIEC. The response message may include AIA-ID; in this case, step S1116 may be skipped.

Alternatively, the response message may be sent as a simple acknowledgement of the reception of the AIA registration request. In this case, it can omit the mentioned information in the response message, and the AIA-ID is sent to the AIA 1101 in a later step (see step S1116).

In step S1108, the AIEC 1103 sends an AIEC registration request to the AIES 1105 to register itself and to register one or multiple AIAs 1101. It is assumed that the AIEC 1103 is hosted by a UE (i.e., an AIH). It is also assumed that the AIEC 1103 has provisioned or discovered the address of the AIES 1105. It is noted that the AIEC 1103 may also receive the AIES address in the AIA registration request message received in step S1102.

The AIEC registration request message sent to the AIES 1105 may include:
AIH-ID: the identifier or the address of the AIH that hosts the AIA 1101. If AIH is a blockchain node or a blockchain user, its blockchain address (e.g., a unique identifier generated from its public key) can be used an AIH-ID.
AIH-Type: indicates if the AIH is an AIMP, an AIMU, or both.
AIH-AI-Capability: the AI capability of this AIH which hosts the AIEC 1103. This could indicate but is not limited to: 1) Computing resource budget for the AIH; 2) Storage resource budget for the AIH; 3) Training data properties such as the number of data samples and the number of features in a data sample; and 4) Input data properties (used for knowledge inference) such as the number of data samples and the number of features in a data sample.
AIA-AI-Capability: the AI capability of the AIA 1101. This could indicate but is not limited to: 1) Computing resource budget for the AIA; 2) Storage resource budget for the AIA; 3) Training data properties such as the number of data samples and the number of features in a data sample; and 4) Input data properties (used for knowledge inference) such as the number of data samples and the number of features in a data sample. If the AIA 1101 already hosts an AI task, AI-Capability can indicate additional information including but not limited to: 1) the unique identifier of the hosted AI task (AI-Task-ID); 2) the type of the hosted AI task (AI-Task-Type); and 3) the address for accessing/managing the AI model of the AI task.
AIEC-ID: the address or a temporary identifier of the AIEC 1103.
Requested-Service-List: a list of services the AIEC 1103 would like to request (e.g., service for accessing the AI task repository, service for accessing the AI model repository, service for discovering an AIA via the AIES 1105, service for tracing an AI task and/or an AI model via the AIES, etc.).
AIA-List: a list of AIAs 1101 and their UE-ID and AIA-AI-Capability which have sent an AIA registration request to the AIEC 1103 (e.g., in step S1102). AIA-AI-Capability was defined above. Each item in AIA-List may also include information received in AIA registration messages. Each item in AIA-List may include an AIA registration flag (AIA-Registration-Flag) to indicate whether the corresponding AIA 1101 needs to be registered with the AIES 1105 and/or the AIEC 1103 needs the AIES 1105 to authenticate this AIA 1101. For example, if AIA-Registration-Flag is TRUE, the corresponding AIA 1101 shall be registered with the AIES 1105 and/or the AIES 1105 shall authenticate this AIA 1101. AIA-Registration-Flag can be derived from AIA-Registration-Type received in the AIA registration message.
Information about local data hosted by the corresponding UE. This information may be useful when AIES 1105 needs to select appropriate AIECs 1103 for a particular AI task. For example, one of the cases is that the AI task is a Federated Learning (FL) task, and a UE could be selected by AIES 1105 as a potential FL client that conducts local training using its local data.

Even in case the AIA 1101 requested local registration with the AIEC 1103 in its AIA registration message, the AIEC 1103 can still include this AIA 1101 in the AIEC registration message to simply report the AIA 1101 to the AIES 1105.

The AIES 1105 receives the AIEC registration request message. It authenticates the AIEC 1103 and approves the services to be allocated to the AIEC 1103, for example, based on preconfigured policies. The AIES 1105 may approve one or multiple services as requested in Requested-Service-List. All approved services are included in Approved-Service-List. The AIES 1105 may (re) assign a unique identifier for the AIEC 1103, referred to as AIEC-ID.

In step S1110, the AIES 1105 may create a new AIEC record for the registered AIEC 1103, which may consist of AIEC-ID, Approved-Service-ID, and/or other information received in the AIEC registration request message. This new AIEC record will be added to the AIEC repository. The AIES may also create a new AIH record if AIH-ID was included in the AIEC registration request message, this new AI record including AIH-ID, AIH-Type, and AIH-AI-Capability as received in the AIEC registration request message, and this new AIH record is stored in the AIH repository.

In case the AIA-List is included in the AIEC registration request message, and especially when the AIEC 1103 needs the AIES 1105 to authenticate one or more AIA 1101, the AIES 1105 may authenticate each AIA 1101 and their UE-ID if the AIA 1101 is hosted at a different UE, for example, based on preconfigured policies. A policy may for example specify that a UE-ID cannot host AIA4L-type agents, or that a UE-ID cannot host more than a certain number of agents. If the authentication passes, the AIES 1105 may (re) assign AIA-ID for each AIA 1101. In step S1112, the AIES 1105 may create a new AIA record for each authenticated AIA 1101, which may include of AIA-ID, and/or other information that are included in the AIA-List and related to this AIA 1101. This new AIA record will be added to the AIA repository.

In step S1114, the AIES 1105 sends a response to the AIEC registration request message to the AIEC 1103. This response message may include:
AIEC-ID assigned in step S1110.
Approved-AIA-List: a list of approved AIAs from step S1112.
Approved-Service-List determined in step S1110.

The AIEC 1103 receives the response message and extracts the AIA-List to know which AIA 1101 has been approved. In step S1116, the AIEC 1103 generates (creates, composes) a new notification message for each approved AIA 1101 including its identifier AIA-ID, and sends the new notification to each approved AIA 1101.

The method illustrated in FIG. 11 can be implemented in different ways, for example 1) use steps S1102-S1106 to register an AIA to an AIEC; 2) use steps S1102-S1104 and steps S1108-S1116 to register an AIA to an AIEC and/or an AIES; 3) use steps S1108, S1110 and S1114 to register an AIEC to an AIES; and 4) use S1108-S1114 to register an AIEC plus its AIAs to an AIES.

### AI Agent Deployment

In certain cases, it is possible that an AIH (e.g., a UE) initially is only equipped with an AIEC, and different AI tasks may need to be executed by different types of AIAs. Accordingly, the AIAs may be dynamically deployed or configured, or installed on AIHs.

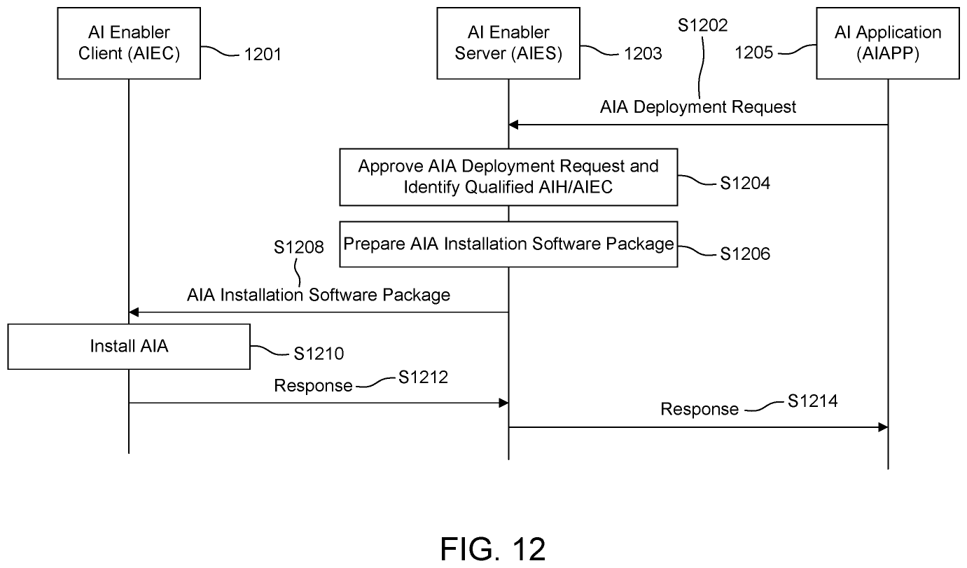

FIG. 12 illustrates a method of AIA deployment according to an embodiment of the present principles.

An AIAPP 1205 intends to run an AI Task-1 that requires a specific type of AIA. However, having communicated with an AIES 1203, the AIAPP 1205 found that there is no available AIA for running the AI Task-1. Accordingly, the AIAPP 1205 determines to install an AIA dynamically on a selected AIH

In step S1202, the AIAPP 1205 sends an AIA deployment request to the AIES 1203. In the request, the AIAPP 1205 may directly indicate the AIH that should install the desired AIA by indicating an AIH-ID, or indicate AIH selection criteria (e.g., location of the AIHs/UEs, AIH-AI-Capability that AIHs/UEs shall have) and rely on the AIES 1203 to find a qualified AIH. In addition, the AIAPP 1205 can specify AIA requirements such as: 1) AIA-Type: the type of AIA (i.e., an AIA4L, an AIA4I, or an AIA4LI) needs to be installed; 2) AIA-AI-Capability: capabilities or performances to be met by the desired AIA to be installed; 3) AIA-Software-Handling: the AIA installation software to be prepared/provided by the AIES 1203, to be downloaded, or the AIA installation software itself; etc. This AIA deployment request may also include:
AIAPP-Type: the type or purpose of this AIAPP 1205 (e.g., to discover and/or deploy an AI task, to discover and/or deploy an AI model, to discover any inferred knowledge, etc.).
AIAPP-ID: the identifier and/or address of the AIAPP 1205.
UE-ID: the identifier and/or address of the UE that hosts the AIAPP 1205.
AI-Task-List: a list of AI tasks including their task identifier (i.e., AI-Task-ID) and their task type (i.e., AI-Task-Type) that the AIAPP 1205 would like to deploy to AIAs in the future.

The AIES 1203 receives the AIA deployment request and, in step S1204, decides whether to approve this request (e.g., based on AIAPP-ID and check the list approved services that have been approved for the AIAPP 1205). In case the request is approved, the AIES 1203 searches the AIH repository to identify a qualified AIH, which matches the AIA requirements and can install the AIA as requested in the AIA deployment request. For example, the AIA requirements from the AIAPP 1205 may require a certain type of training data; as such, only the AIHs that provide such training data can be selected by the AIES 1203 as a qualified AIH.

In step S1206, the AIES 1203, based on the AIA requirements as indicated by the AIAPP 1205, prepares an AIA installation software package. Alternatively, the software package is provided in the AIA deployment request.

In step S1208, the AIES 1203 sends the AIA installation software package to the AIEC 1201 of the selected AIH.

In step S1210, the AIEC 1201 installs the AIA software package and starts to run the desired AIA. The AIH may generate an identifier or an address for the installed AIA (i.e., AIA-ID) and pass the AIA-ID to the AIEC 1201.

In step S1212, the AIEC 1201 sends a response to the AIES 1203 regarding the successful (or unsuccessful) installation of the desired AIA. This response can also be regarded as a request to register the installed AIA. In other words, this step may be the same as step 1108 in FIG. 11.

In step S1214, the AIES 1203 sends a response to the AIAPP 1205. The response may include:
AIH-ID: identifier or address of the AIH selected in step S1204.
AIEC-ID: identifier or address of the AIEC 1201.
AIA-ID: identifier or address of the AIA installed in step S1210.

### AI Task Management

### AI Task Deployment

AI AIAPP can leverage an AIES to deploy an AI task to an AIA. The AIES just needs the AIAPP to upload the AI task and can find appropriates AIAs to host the AI task to be deployed.

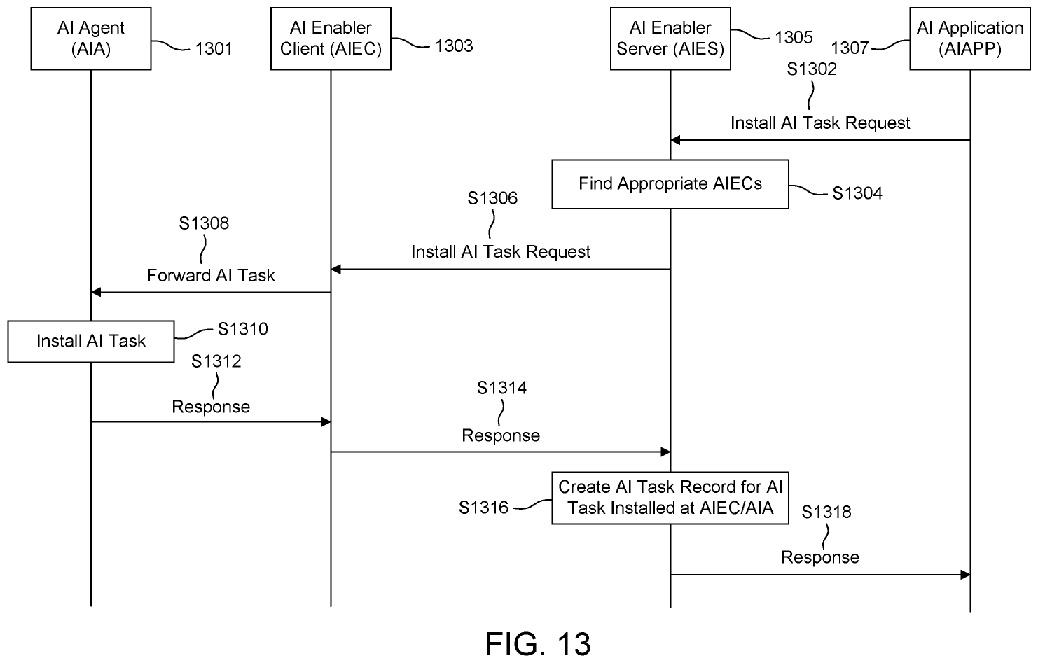

FIG. 13 illustrates a method of AI task deployment according to an embodiment of the present principles.

In step S1302, an AIAPP 1307 in a network sends a request to an AIES 1305 to install an AI task. This request may include:
AIAPP-ID: identifier and/or address of the AIAPP 1307 assigned at registration at the AIES 1305.
AIEC-ID: identifier and/or address of one or multiple AIECs 1303 on which the AIAPP 1307 wants to install the AI task. The AIAPP 1307 may have discovered the AIECs 1303 from the AIES 1305 using a separate procedure.
Num-of-AIECS: number of AIECs 1303 on which the AI task should be deployed.
AI-Task-Content: software code of the AI task. If this parameter is not contained in step S1302, the AIES 1305 can use AI-Task-ID to identify the corresponding AI task and find AI-Task-Content from the AI task repository or download AI-Task-Content from other places (e.g., a DSS).
AI-Task-ID: unique identifier of the selected AI task.
AI-Model-ID: identifier of an existing AI model, which the AIAPP wants the AIA to retrieve and install with the AI task. This information may not be needed when the AI task is for learning. If AI-Model-ID is included in the request, AI-Model-Content may be omitted.
AI-Model-Content: content of an AI model. This information may be optional in case the AI task is for learning. Even in case the AI task is for inferring knowledge, this information could be optional since the AIA 1301 can use AI-Model-ID to retrieve an AI model. When AI-Model-Content is included in this request, AI-Model-ID is not needed. If the AI task is a semi-supervised learning task, AI-Model-Content or AI-Model-ID is needed.
Data-Properties: properties of data to be used for running the AI task (e.g., training data, input data for knowledge inference)

The AIES 1305 receives and authenticates the request (e.g., check if AIAPP-ID is a valid ID stored in the AIAPP repository). If the authentication passes, the AIES 1305 may, in step S1304, find one or multiple appropriate AIECs 1303 from its AIEC repository. In case AIEC-ID was included in the request, the AIES 1305 may not need to find any new AIEC. The AIES 1305 may determine multiple AIECs 1303 as denoted by Num-of-AIECs and on which to install the same AI task. For each AIEC 1303, the AIES 1305 may identify the appropriate AIA 1301 (i.e., to find an AIA-ID for each AIEC 1303 from AIA repository).

Steps S1306-S1316 are performed for each AIEC 1303 determined in step S1304 and/or indicated in the request in step S1302.

In step S1306, the AIES 1305 sends a request to an AIEC to install the AI task. This request may include:
AI-Task-Content: as in step S1302 or the AIES finds it from AI task repository or download it from other places (e.g., a DSS).
AI-Task-ID: as in step S1302.
AI-Model-ID: as in step S1302.
AI-Model-Content: as in step S1302.
AIES-ID: identifier and/or address of the AIES 1305.
AIA-ID: determined in step S1304.

In step S1308, the AIEC 1303 forwards the AI task content (and AI-Model-Content if any) in a message to the AIA 1301 as denoted by the AIA-ID received in the request in step S1306.

In step S1310, the AIA 1301 installs the AI task and generates an AI-Task-Address. The AI-Task-Address (e.g., an Application Programming Interface (API), a Fully Qualified Domain Name (FQDN), a Uniform Resource Locator (URL), an IP address, an IP address along with a TCP/UDP port number, etc.) allows other entities (e.g., the AIEC 1303, the AIAPP 1307, the AIES 1305) to manage this AI task (e.g., pause the AI task, resume the AI task, update the AI task with new software code, retrieve the output of the AI task, update the AI model of the AI task, download the AI model of the AI task, change other properties of the AI task, etc.)

In step S1312, the AIA 1301 sends a response including the AI-Task-Address to the AIEC 1303.

In step S1314, the AIEC 1303 sends a response to the AIES 1305. This response may include AIEC-ID and AI-Task-Address. It is noted that AIEC-ID is the identifier and/or the address of the AIEC 1303.

In step S1316, the AIES 1305 generates an AI task record, which may include:
AIEC-ID: determined in step S1304.
AIA-ID: determined in step S1304.
AI-Task-Address: received from the AIEC in the response in step S1314.
Information received from the AIAPP 1307 in the request in step S1302.

The AIES 1305 may publish the AI task record to a DSS (e.g., a distributed ledger) or store the installed AI task in AI task repository.

In step S1318, the AIES 1305 sends a response to the AIAPP 1307. This response may include one or multiple pieces of information in the created AI task record.

### AI Task Migration

It is possible that certain AI tasks need to be migrated due to various reasons (e.g., need for more computing power) which is especially true for AI training tasks that last for a long time.

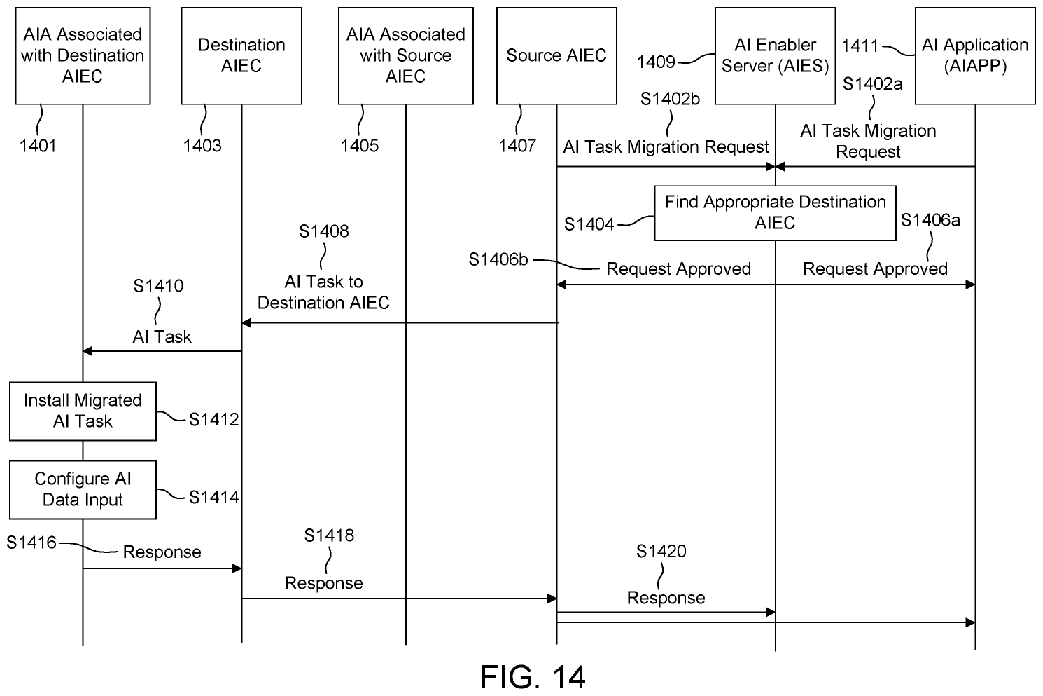

FIG. 14 illustrates a method of AI task migration according to an embodiment of the present principles.

A triggering event (not illustrated) for AI task migration may occur on an AIAPP or on a source AIA/AIH running an AI task. For example, the source AIA/AIH may experience a sudden reduction of computing power or the unavailability of training data and send an AI task migration trigger to the source AIEC that then requests migration of the AI task from an AIES. The triggering event causes transmission an AI task migration request to be sent from the entity experiencing (or being associated with the entity experiencing) the triggering event. In other words, typically either step 1402a or S1402b is performed.

In step S1402a, the AIAPP 1411 sends an AI task migration request to an AIES 1409. The request may include:
AIAPP-ID: identifier or address of the AIAPP 1411.
AI-Task-ID: identifier or address of the AI task to be migrated from a source AIA/AIH (connected by a source AIEC 1407) to a destination AIA/AIH (connected by a destination AIEC 1403).
Source-AIEC-ID: identifier or address of the source AIEC 1407 which connects the source AIA 1405 to the AIES 1409. This information is omitted if the AIAPP 1411 does not know where to migrate the AI task from.
Destination-AIEC-ID: identifier or address of the destination AIEC 1403 which connects the destination AIA 1401 to the AIES 1405. This information is omitted if the AIAPP 1411 does not know where to migrate the AI task to.
Destination-AIEC-Selection-Criteria: the criteria for the AIES 1409 to identify and select qualified destination AIEC 1403 (and/or qualified destination AIA 1401), to which the AI task can be migrated. The criteria could be related to AIA-AI-Capability and/or AIH-AI-Capability. This information can be omitted in case the request includes Source-AIEC-ID and/or Destination-AIEC-ID.

In step S1402b, the source AIEC 1407 sends an AI task migration request to the AIES 1409. The request may include:
Source-AIEC-ID: identifier or address of the source AIEC 1407.
Source-AIA-ID: identifier or address of the source AIA 1405.
Source-AIH-ID: identifier or the address of the source AIH.
AI-Task-ID: same as in step S1402a.
Destination-AIEC-ID: same as in step S1402a.
Destination-AIEC-Selection-Criteria: same as in step S1402a.

The AIES 1409 receives the AI task migration request, examines the received request and decides whether to approve it. If the request is approved, in step S1404, the AIES 1409 determines where to migrate the AI task. The AIES 1409 may use Destination-AIEC-Selection-Criteria received from AIAPP 1411 or the source AIEC 1407 to identify an appropriate destination AIEC/AIA/AIH. For example, the AIES 1409 can search the AIEC repository (or AIA repository, or AIH repository) to compare Destination-AIEC-Selection-Criteria against AIA-AI-Capability and/or AIH-AI-Capability of each AIEC record (or AIA record, or AIH record) to find the appropriate and qualified destination AIEC 1403 (and/or qualified destination AIA).

The AIES 1409 confirms the AI task migration request has been approved by sending a message to the relevant entity or device, i.e. the source AIEC 1407 (step S1406b) or the AIAPP (step S1406a).

In step S1406a, that is only needed if the AI task migration request was from the AIAPP 1411 (i.e., step 1402a), the message may include:
Source-AIEC-ID: identifier or address of the source AIEC 1407.
Source-AIA-ID: identifier or address of the source AIA 1405.
Source-AIH-ID: identifier or address of the source AIH hosting the source AIA 1405.
Destination-AIEC-ID: identifier or address of the destination AIEC 1403 determined in step S1404.
Destination-AIA-ID: identifier or address of the destination AIA 1401 determined in step S1404.
Destination-AIH-ID: identifier or address of the destination AIH hosting the destination AIA 1401 determined in step S1404.

In case the AI task migration request is sent from the AIAPP 1411 (i.e., in step S1402a), the AIAPP 1411 can further contact the source AIEC 1407 to start the migration.

In step S1406b, the AIES 1409 sends a message to the source AIEC 1405. If the AI task migration request was from the AIAPP 1411 (i.e., step 1402a) the AIES 1409 uses this message to notify the AIEC 1405 to execute the AI task migration. If the AI task migration request was from the source AIEC 1405 (i.e., step S1402b), the AIES 1409 uses this message to indicate that the request was approved. The message in step S1406b may include:
AIAPP-ID: identifier or address of the AIAPP 1411 if the AI task migration request was from the AIAPP 1411 (i.e., step 1402a).
AI-Task-ID: same as in step S1402a.
Destination-AIEC-ID: identifier or address of the destination AIEC 1403 determined in step S1404.
Destination-AIA-ID: identifier or address of the destination AIA 1401 determined in step S1404.
Destination-AIH-ID: identifier or address of the destination AIH determined in step S1404.

The Source AIEC prepares the AI task migration. It sends the AI task migration request to the Destination AIEC 1403 via step S1408. This request may contain the parameters such as AI-Task-Content, AI-Task-ID, AI-Model-ID, AI-Model-Content, AIES-ID, AIA-ID, and AI-Task-Migration-Instructions. AI-Task-Migration-Instructions may specify more AI-specific migration information and/or policies; for example, one of the major differences between a normal software migration and the AI task migration is that in addition to migrating the software instance context, the data needed for the AI tasks may also need to be configured. As such, AI-Task-Migration-Instructions may contain the following information:

If the migrated AI task is an AI training task, then the Destination AIEC needs to know where the training data comes from. For example, it could just use the local training data hosted by the Destination AIEC. Alternatively, the data hosted by the Source AIEC may also need to be migrated to the Destination AIEC.

If the migrated AI task is an AI inference task, then the Destination AIEC needs to know where the input data come from in order to conduct inference over the input data.

In step S1410, the destination AIEC 1403 forwards the AI task migration request to the destination AIA 1401 associated with the destination AIEC 1403.

In step S1412, the destination AIA 1401 installs the migrated AI task.

In step S1414, the destination AIA 1401 configures the input for the migrated AI task (e.g., what training data should be used for the AI training task, or what the input data should be used for the AI inference task).

In step S1416, the destination AIA 1401 sends a response to the destination AIEC 1403 indicating that the AI task migration is complete.

In step S1418, the destination AIEC 1403 sends a response to the source AIEC 1407 indicating that the AI task migration is complete. The Source AIEC 1407 may, in step S1420, forward the response to the AIES 1409 and/or the AIAPP 1411.

### Federated Learning (FL) Task Deployment

A particular type of AI task is the Federated Learning (FL) task. In typical FL learning, there is one FL server and multiple FL clients. In each training round, the FL clients use their local data to conduct local training to generate local model updates that are submitted to the FL server for aggregation to generate global model update. The aggregated global model update is disseminated to FL clients to be used for next round of local training at FL clients.

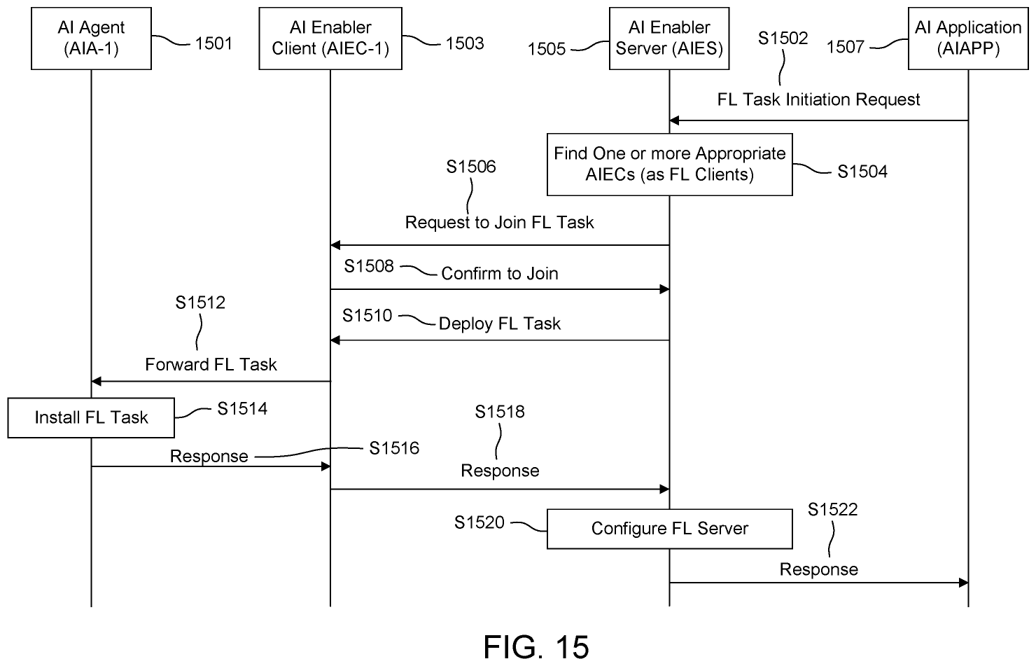

FIG. 15 illustrates a method of FL task migration according to an embodiment of the present principles.

An AIAPP 1507 is to deploy a FL task, FL Task-1. In step S1502, the AIAPP 1507 sends a FL task deployment request to an AIES 1505, along with requirements regarding the FL tasks. For example, a requirement could be FL client selection criteria (e.g., AIA-AI-Capability such as the training data properties). The AIAPP 1507 may include an initial FL global model in the request, which is to be used by FL clients to start the local training. In addition, the AIAPP 1507 may indicate training instructions (e.g., some AI model hyperparameters) for each FL client to follow during the local training. In addition, this request may include information described with reference to the request in step S1302 in FIG. 13.

In step S1504, the AIES 1505 selects one or more appropriate FL clients based on the FL client selection criteria sent from the AIAPP 1507. For example, an appropriate AIEC and/or an appropriate AIA with the required AIH-AI-Capability or AIA-AI-Capability can be regarded as a candidate FL client.

Steps S1506-S1518 are performed for each selected FL client (e.g., AIEC-1 and AIA-1)

In step S1506, the AIES 1505 sends an invitation request to join FL Task-1 to the AIEC-1 1503, one of the selected FL clients. This request may include information similar to that in the request in step S1302 in FIG. 13 (e.g., Data-Properties, AI-Task-Type).

In step S1508, the AIEC-1 1503 sends a confirmation to join the FL Task-1 to the AIES 1505.

In step S1510, the AIES 1505 sends a deployment request to the AIEC-1 1503 to deploy the related software code and training instructions of FL Task-1 to the AIEC-1. The deployment request can include information in the request in step S1502.

In step S1512, the AIEC-1 1503 forwards the request to the AIA-1 1501.

In step S1514, the AIA-1 1501 installs the related software code of the FL Task-1 and completes the configuration.

The AIA-1 1501 generates an AI-Task-address, that it includes in a response sent to the AIEC-1 1503 in step S1516.

In step S1518, the AIEC-1 1503 forwards the response to the AIES 1505. This response may include AIEC-1-ID and AI-Task-Address. It is noted that AIEC-1-ID is the identifier and/or the address of the AIEC-1 1503.

In step S1520, the AIES 1505 configures its own configuration in case it needs to act as an FL server in FL Task-1. Alternatively, another AIEC could be selected by the AIES 1505 to act as the FL server in the FL Task-1. In that case, the FL server sends related software code and FL instructions to the selected AIEC, which will act as the FL server. For example, the AIES 1505 can use FL instructions to indicate to the AIEC (to be acting as FL server) the AIECs that have been selected as the FL clients in this task. The AIES 1505 generates an AI task record, which may include:
the AI-Task-Address received in step S1518.
information received in step S1502.
the address or the identifier of each AIEC/AIA on which the FL task-1 has been successful installed.
the address or the identifier of the selected FL server.

In step S1522, the AIES 1505 sends a response to the AIAPP 1507 confirming that the FL Task-1 has been deployed. This response may include AI-Task-Address, the identifier of the AIA-1, the identifier of the AIEC-1, the identifier of the AIES, and/or the identifier of the AIEC being selected as the FL server.

### AI Model Management

### AI Model Registration

An AIA, after learning an AI model, can register the AI model to an AIES. The AIA leverages an AIEC to register the AI model to the AIES. After the AI model is registered to the AIES, the AIES creates an AI model record and stores the AI model record to AI model repository.

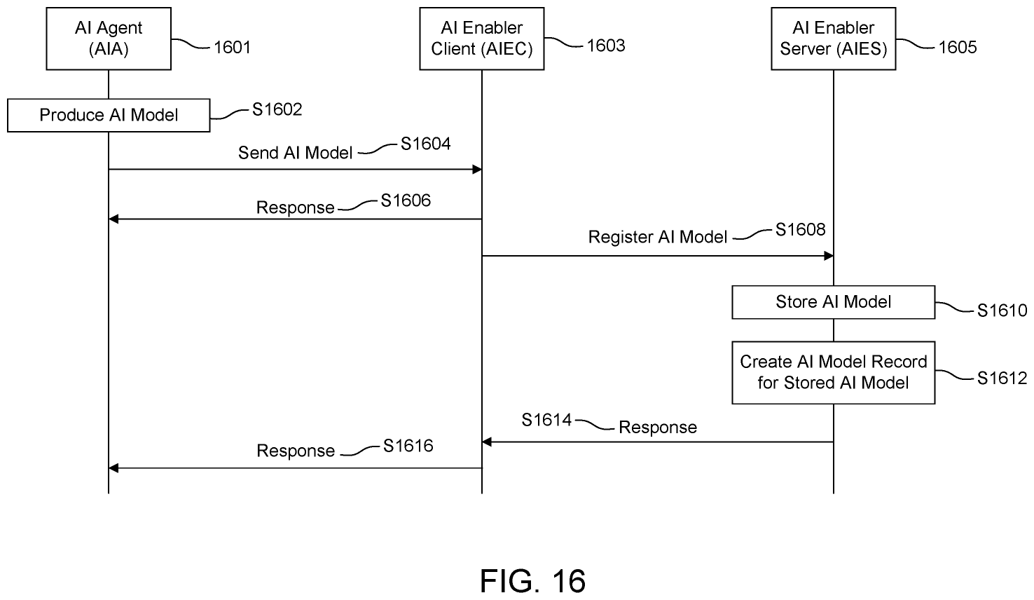

FIG. 16 illustrates a method of AI model registration according to an embodiment of the present principles.

In step S1602, an AIA 1601, having completed AI training, produces an AI model.

In step S1604, the AIA 1601 sends a message with the produced AI model to an AIEC 1603. This message may include:
AI-Model-ID: identifier of the produced AI model. It may be the identifier of a previously registered AI model as indication that AI-Model-Content (see below) is an update to a previously registered AI model denoted by AI-Model-ID.
AI-Model-Content: the AI model (e.g., all parameters/weights of a DNN) and the model version, if the AI model is fully trained. If the model is not fully trained, AI-Model-Content is not needed. Even for a fully trained AI model, the AIA may skip this parameter and decide not to upload the model content to the AIES; instead, other entities can only discover AI-Model-Address and use separate steps to retrieve the AI model content from the AIA directly.
AI-Model-Address: the address of the AI model, fully trained or still under training at the AIA 1601. With AI-Model-Address, other entities (e.g., an AIES, an AIH, an AIAPP) can check the status of the AI model (e.g., fully trained or partially trained) from the AIA 1601, and download the AIA model from the AIA 1601 after it has been fully trained. If AI-Model-Content is not included in step S1604, other entities can use AI-Model-Address to come to the AIA to retrieve the model content at a later time.
AIA-ID: identifier and/or address of the AIA 1601.
AI-Model-Registration-Type: indicate if the AI model should be registered with the AIEC, the AIES, or both of them.

In step S1606, the AIEC 1605 can send an acknowledgment of the message to the AIA 1601.

The AIEC 1603 can determine, for example based on local policies or an explicit indication that the AIA can piggyback in step S1404 (i.e., AI-Model-Registration-Type), to register the AI model to an AIES 1605. In this case, in step S1608, the AIEC 1603 sends a request message to the AIES 1605 to register the AI model. This request may include:
AI-Model-Content: received in the message in step S1604.
AI-Model-Usage-Constrains: constraints regarding usage of the AI model, such as when the registered model can be discovered and/or used by which entities. As an example, this may include a list of allowed AIAs indicating that only AIAs on this list can discover and use this AI model.
AI-Model-ID: received in the message in step S1604.
AI-Model-Address: received in the message in step S1604.
AIA-ID: received in the message in step S1604.
AIEC-ID: identifier or address of the AIEC 1603.

The AIES 1605 receives the request message. In case AI-Model-Content is included in the message, in step S1610, the AIES 1605 stores the AI model in AI model repository. In case the AIA 1601 requested an update to a previously registered AI model in the message in step S1604, the AIES 1605 uses the new AI-Model-Content included in that message and forwarded to the AIES 1605 to replace the previous version of the AI model. The AIES 1605 may publish the AI model content to a DSS (e.g., a distributed ledger).

In step S1612, the AIES 1605 creates an AI model record for the AI model indicated in the message in step S1608. The AIES 1605 may publish the AI model to a DSS (e.g., a distributed ledger). For example, the AIES 1605 may create a transaction containing the AI model and send the transaction to the distributed ledger. The AI model record may contain the following information, which can be discovered and/or exposed to other entities such as AIMUs:
AI-Model-ID: Same as step S1608 if it is contained in step S1608. If step S1608 does not contain AI-Model-ID, it means the AI model is registered at the first time and the AIES will create AI-Model-ID for the registered AI model. Later, the AIA can use AI-Model-ID to update a registered AI model.

AI-Model-Usage-Constraints: Same as step S1608 if it is contained in step S1608. If step S1608 does not contain this parameter, the AIES itself may determine some AI model usage constraints.

AI-Model-Address: Same as step S1608 if it is contained in step S1608; otherwise, this parameter is not needed.

AI-Model-Content: Same as step S1608 if it is contained in step S1608; otherwise, this parameter is not needed.

AI-Model-Mode: Indicates the AI model is registered.

AIA-ID: Same as in step S1608.

AIEC-ID: Same as in step S1608.

In step S1614, the AIES 1605 sends a response to the AIEC 1603. The response may include:
AI-Model-ID: same as in step S1612.
AI-Model-Record-ID: the identifier of the AI model record created in step S1612.

In step S1616, the AIEC 1603 may forward the response received in step S1614 to the AIA 1601.

### AI Model Discovery and Deployment

Entities (e.g., an AIAPP and an AIA) can discover a registered AI model from an AIES and deploy the discovered AI model to an AIA.

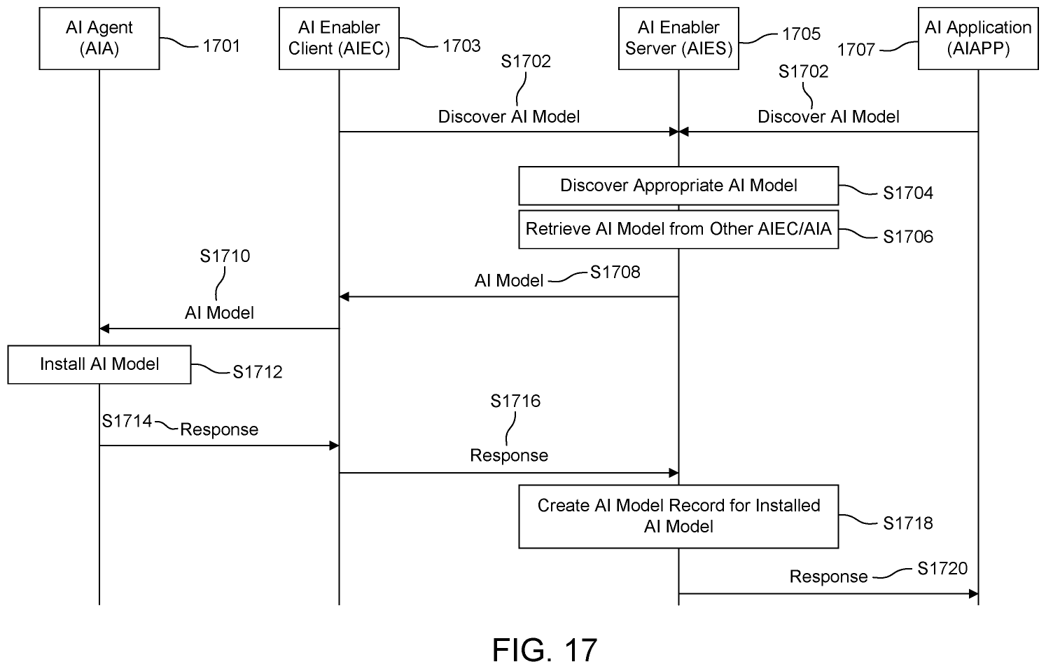

FIG. 17 illustrates a method of AI model discovery and deployment according to an embodiment of the present principles. In the method, an AIAPP 1707 or an AIEC 1703 discovers an AI model from an AIES 1705.

In step S1702, an AIEC 1703 or an AIAPP 1707 sends a request message to an AIES 1705 to discover an AI model. The request may include AIEC-ID (if the request is from the AIEC 1703) or AIAPP-ID (if the request is from the AIAPP 1707). The request may include AI model discovery criteria, indicating one or multiple following properties of AI models to be discovered:
AI-Model-Type: type of the AI model to be discovered. This could describe the type of the AI model in different levels or granularities such as but not limited to: 1) algorithm-level: if the AI model is a linear regression model, a classification model, a DNN model, etc.; 2) application-level: if the AI model is for wireless channel prediction, image classification, pattern recognition, nature language processing, financial market prediction, autonomous driving, etc. If the AI model is a DNN model, AI-Model-Type can also indicate the number of layers and the number of neurons of the DNN.
AI-Model-ID: identifier of a previously downloaded AI model. The AIA 1701 can use AI-Model-ID to download a new version of the AI model from the AIES.

The AIAPP 1707 may also include an AIA-ID or an AIEC-ID to which the discovered AI model should be deployed.

In step S1704, the AIES 1705 discovers in its AI model repository at least one AI model that matches the received criteria (e.g., AI-Model-Type). The AIES 1705 uses AI-Model-Address1 to denote where the AI model was discovered.

In step S1706, the AIES 1705 retrieves the AI model. The AI model may for example be retrieved from a DSS (e.g., a distributed ledger) or from another AIEC/AIA (i.e., other than AIA 1701 and AIEC 1703), which acts as an AIMP and produces AI models. The AIES 1705 uses AI-Model-Address2 to denote where the AI model was retrieved.

In step S1708, the AIES 1705 sends a message with the determined AI model to the AIEC 1703. If the request message in step S1702 was sent from the AIEC 1703, the AIES 1705 knows its address. If the request message was sent from the AIAPP 1707, the AIAPP 1707 may have indicated an AIA-ID or an AIEC-ID in the request message. If only AIA-ID is included, the AIES 1705 can use the AIA-ID to search its AIA repository to find the AIEC 1703 that can reach the AIA 1701. This message may include:
AIAPP-ID: identifier and/or address of the AIAPP 1707 if the request message in step S1702 was sent from the AIAPP 1707.
AIEC-ID: identifier and/or address of the AIEC 1703.
AIA-ID: identifier and/or address of the AIA 1701.
AI-Model-ID: identifier of the AI model being sent for deployment at the AIA 1701.
AI-Model-Content: the content of the AI model being sent for deployment at the AIA 1701.

AI-Model-Address1: Same as step S1704.

AI-Model-Address2: Same as step S1706.

In step S1710, the AIEC 1703 forwards the AI model to the AIA 1701.

In step S1712, the AIA 1701 installs the AI model.

In step S1714, the AIA 1701 sends a response to the AIEC 1703. The response may include:
AIA-ID: the identifier of the AIA 1701.
AI-Model-Push-Address: the address that the AIES 1705 or other entities can use to push the content of a new fully trained AI model to the AIA 1701.

In step S1716, the AIEC 1703 sends a response to the AIES 1705. The response may include:
AIEC-ID: identifier or address of the AIEC 1703.
AIA-ID: as received from the AIA 1701.
AI-Model-Push-Address: as received from the AIA 1701.

The AIES receives the response and, in step S1718, creates an AI model record based on the information in the response. The AI model record may include the information received from in the response in step S1716. The AI model record also may include:
AIAPP-ID: received in step S1702.
AI-Model-Address1: determined in step S1704.
AI-Model-Address2: determined in step S1706.
AI-Model-ID: same as in step S1708.

In step S1720, the AIES 1705 may send a notification to the AIAPP 1707. The notification may include information from the AI model record.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 1 6 or means-plus-function claim format, and any claim without the terms “means for” is not so intended.

1. A device comprising:
at least one processor configured to:
receive, from an Artificial Intelligence, AI, entity, a first request for a first registration;
create a record for the AI entity, the record comprising information indicative of the first registration; and
transmit, to a further device, a second request for a second registration of an AI client on the device and of at least one AI entity including the AI entity.

2. The device of claim 1, wherein the AI entity is an AI application.

3. The device of claim 2, wherein the information indicative of the first registration comprises at least one of a time of registration, a type of the AI application, a purpose of the AI application, an identifier of the AI application, an address of the AI application, an identifier of a hosting device of the AI application, an address of a hosting device of the AI application, a list of AI tasks to be deployed by the AI application, that the first request for a first registration is for registration with the device, that the first request for a first registration is for registration with the further device and an identifier or an address of the further device.

4. The device of claim 3, wherein the first request for a first registration comprises information indicative of at least one of the type of the AI application, the purpose of the AI application, the identifier of the AI application, the address of the AI application, the identifier of the hosting device of the AI application, the address of the hosting device of the AI application, the list of AI tasks to be deployed by the AI application, that the first request for a first registration is for registration with the device, that the first request for a first registration is for registration with the further device and the identifier or the address of the further device.

5. The device of claim 2, wherein the second request for a second registration comprises information indicative of at least one of an identifier of the device, an address of the device, a blockchain address of the device, resources that the device can allocate for AI tasks, at least one service requested by the device, and a list of AI applications from which the device has received registration requests.

6. The device of claim 1, wherein the at least one processor configured to:
receive, from the further device, information indicative of at least one of an identifier of the device, services approved for use by the device, and approved AI applications.

7. The device of claim 1, wherein the AI entity is an AI agent hosted by an AI host and having a capability to at least one of train an AI model and use a trained AI model to infer a result.

8. The device of claim 7, wherein the information indicative of the first registration comprises at least one of a time of registration, an identifier of the AI agent, an identifier of the AI host, that the first request for a first registration is for registration with the device, that the first request for a first registration is for registration with the further device and an identifier or an address of the further device.

9. The device of claim 8, wherein the second request for a second registration comprises information indicative of at least one of an identifier of the AI host, an address of the AI host, a blockchain address of the AI host, resources that the AI agent can allocate for AI tasks, at least one service requested by the device, and a list of AI agents from which the device has received registration requests.

10. A method, performed by a device, the method comprising:
receiving, from an Artificial Intelligence, AI, entity, a first request for a first registration;
creating a record for the AI entity, the record comprising information indicative of the first registration; and
transmitting, to a further device, a second request for a second registration of an AI client on the device and of at least one AI entity including the AI entity.

11. The method of claim 10, wherein the AI entity is an AI application.

12. The method of claim 11, wherein the information indicative of the first registration comprises at least one of a time of registration, a type of the AI application, a purpose of the AI application, an identifier of the AI application, an address of the AI application, an identifier of a hosting device of the AI application, an address of a hosting device of the AI application, a list of AI tasks to be deployed by the AI application, that the first request for a first registration is for registration with the device, that the first request for a first registration is for registration with the further device and an identifier or an address of the further device.

13. The method of claim 12, wherein the first request for a first registration comprises information indicative of at least one of the type of the AI application, the purpose of the AI application, the identifier of the AI application, the address of the AI application, the identifier of the hosting device of the AI application, the address of the hosting device of the AI application, the list of AI tasks to be deployed by the AI application, that the first request for a first registration is for registration with the device, that the first request for a first registration is for registration with the further device and the identifier or the address of the further device.

14. The method of claim 11, wherein the second request for a second registration comprises information indicative of at least one of an identifier of the device, an address of the device, a blockchain address of the device, resources that the device can allocate for AI tasks, at least one service requested by the device, and a list of AI applications from which the device has received registration requests.

15. The method of claim 10, further comprising:
receiving, from the further device, information indicative of at least one of an identifier of the device, services approved for use by the device, and approved AI applications.

16. The method of claim 10, wherein the AI entity is an AI agent hosted by an AI host and having a capability to at least one of train an AI model and use a trained AI model to infer a result.

17. The method of claim 16, wherein the information indicative of the first registration comprises at least one of a time of registration, an identifier of the AI agent, an identifier of the AI host, that the request for registration is for registration with the device, that the first request for a first registration is for registration with the further device and an identifier or an address of the further device.

18. The method of claim 17, wherein the second request for a second registration comprises information indicative of at least one of an identifier of the AI host, an address of the AI host, a blockchain address of the AI host, resources that the AI agent can allocate for AI tasks, at least one service requested by the device, and a list of AI agents from which the device has received registration requests.
